(19) United States
(12) Patent Application Publication
(10) Pub. No.: US 2026/0030193 A1
(43) Pub. Date: Jan. 29, 2026

(54) SEMICONDUCTOR DEVICE FOR CHANGING LINK SPEED AND LINK WIDTH OF PCIE LINK AND OPERATING METHOD THEREOF

(71) Applicant: Samsung Electronics Co., Ltd., Suwon-si (KR)

(72) Inventors: Jongheon JEONG, Suwon-si (KR); Kangrak KWON, Suwon-si (KR); Youngkyu PARK, Suwon-si (KR); Kyungduk LEE, Suwon-si (KR); Youngju CHO, Suwon-si (KR); Hyeokseo JOO, Suwon-si (KR)

(73) Assignee: Samsung Electronics Co., Ltd., Suwon-si (KR)

(21) Appl. No.: 19/175,301

(22) Filed: Apr. 10, 2025

(30) Foreign Application Priority Data
Jul. 23, 2024 (KR) 10-2024-0097514

(51) Int. Cl. G06F 13/42

(52) U.S. Cl. CPC G06F 13/4221; G06F 2213/0026

(57) ABSTRACT

Provided are a semiconductor device for changing a link speed and a link width of a peripheral component interconnect express (PCIe) link and an operating method thereof. The semiconductor device includes the PCIe link including a plurality of lanes, and a controller configured to transceive a data link layer packet (DLLP) including a number of times of transition and a maximum number of times of transition from an L0 state to an L0p state through the PCIe link, based on a first bit error rate (BER) of a data packet received through the PCIe link and a first criterion value in the L0 state, and determine whether to perform at least one of a link speed changing operation performed in a recovery state, or a link width changing operation performed in the L0p state, based on the number of times of transition and the maximum number of times of transition.

### CROSS-REFERENCE TO RELATED APPLICATION

This application is based on and claims priority under 35 U.S.C. § 119 to Korean Patent Application No. 10-2024-0097514, filed on Jul. 23, 2024, in the Korean Intellectual Property Office, the disclosure of which is incorporated by reference herein in its entirety.

### BACKGROUND

The present inventive concepts relate to an electronic device, and more particularly, to a semiconductor device for changing a link speed and a link width of a peripheral component interconnect express (PCIe) link and an operating method thereof.

Electronic devices may communicate through various types of interfaces. For example, electronic devices may transceive packets through a PCIe interface. In the market related to storage devices, bandwidths of high-speed interfaces based on PCIe are increasing. As bandwidths of high-speed interfaces increase, the performance degradation of a PCIe link may be considered a fatal flaw in communication between devices, and it is important and/or advantageous to perform communication at a high speed without interrupting communication through the PCIe link. In other words, it is important and/or advantageous to maintain continuity of communication and high data transfer rates.

Electronic devices that communicate through PCIe interfaces follow rules, such as the link training and status machine (LTSSM) rule, as defined in the PCIe standard, and the PCIe standard is applied without exception to devices that communicate through PCIe interfaces. However, due to various exceptional situations and errors that may occur in the actual mounting environment, operations according to the existing PCIe standard may cause unnecessary performance degradation. Accordingly, it may be advantageous to provide a technology for simultaneously maintaining data communication with respect to various errors in a PCIe link and preventing or reducing performance degradation while following the PCIe standard.

### SUMMARY

Some example embodiments of the present inventive concepts provide a semiconductor device and/or an operating method of the semiconductor device for changing a link speed of a peripheral component interconnect express (PCIe) link while maintaining and ensuring continuity of communication and changing of a link width preferentially while following the link training and status machine (LTSSM) rule.

According to some example embodiments, there is provided a semiconductor device including a peripheral component interconnect express (PCIe) link including a plurality of lanes, and a controller configured to perform a communication operation of transceiving of a data link layer packet (DLLP), the DLLP including a number of times of transition and a maximum number of times of transition from an L0 state to an L0p state of a PCIe through the PCIe link, based on a first bit error rate (BER) of a data packet received through the PCIe link and a first criterion value in the L0 state, and determine whether to perform, based on the number of times of transition and the maximum number of times of transition, at least one of a link speed changing operation of reducing a link speed of the PCIe link in a recovery state of the PCIe, or a link width changing operation of reducing a link width of the PCIe link in the L0p state.

According to some example embodiments, there is provided an operating method of a semiconductor device, the operating method including a link management operation of transceiving a link management data link layer packet (DLLP), the DLLP including a number of times of transition and a maximum number of times of transition from an L0 state to an L0p state of a peripheral component interconnect express (PCIe), through a PCIe link including a plurality of lanes in the L0 state, a link speed changing operation of setting a link speed lower than a link speed of the PCIe link in a recovery state of the PCIe based on a first number of times of transition being greater than the maximum number of times of transition, and a link width changing operation of setting a link width less than a link width of the PCIe link in the L0p state of the PCIe, based on a second number of times of transition being less than or equal to the maximum number of times of transition.

According to some example embodiments, there is provided a semiconductor device including a port connected to a peripheral component interconnect express (PCIe) link, wherein the port is configured to transceive a data link layer packet (DLLP) in an L0 state of a PCIe, and the DLLP includes a DLLP type field indicating a link management DLLP, a link management type field indicating an error count among a plurality of types of link management of the PCIe, a speed down field indicating whether to speed down on a speed of the PCIe link, an L0p command field indicating an L0p command or an L0p response, an L0p entry count field indicating a number of times of transition from the L0 state to the L0p state of the PCIe, and an L0p entry limit field indicating a maximum number of times of transition with respect to the number of times of transition.

### BRIEF DESCRIPTION OF THE DRAWINGS

Some example embodiments will be more clearly understood from the following detailed description taken in conjunction with the accompanying drawings in which:

FIG. 1 is a block diagram illustrating a system according to some example embodiments;

FIG. 2 is a layering diagram illustrating an interconnect architecture according to some example embodiments;

FIG. 3 is a state diagram of a link training and status machine (LTSSM) according to some example embodiments;

FIG. 4 is a diagram illustrating a comparative example in which an L0 state and a recovery state repeatedly transition according to some example embodiments;

FIG. 5 is a diagram for explaining a comparative example in which a link speed is reduced before reducing a link width according to some example embodiments;

FIGS. 6 and 7 are diagrams illustrating a format of each of link management data link layer packets (DLLPs) according to some example embodiments;

FIG. 8 is a diagram for explaining an L0p command field of link management DLLPs according to some example embodiments;

FIGS. 9, 10, and 11 are flowcharts illustrating operations of a semiconductor device, according to some example embodiments;

FIG. 12 is a diagram for explaining a method of reducing a link speed, according to some example embodiments;

FIG. 13 is a diagram for explaining a method of reducing a link width, according to some example embodiments;

FIG. 14 is a diagram illustrating an example embodiment in which a reduced link width is set to a maximum link width, according to some example embodiments of the present inventive concepts;

FIG. 15 is a block diagram of a storage system according to some example embodiment; and

FIG. 16 is a flowchart of an operating method of a semiconductor device, according to some example embodiments.

### DETAILED DESCRIPTION

Hereinafter, some example embodiments of the present inventive concepts will be described in detail with reference to the attached drawings.

The expressions “first,” “second,” etc., as used herein, may describe various components, regardless of order and/or importance, and are only used to distinguish one component from another, and do not limit the components. For example, a first user device and a second user device may indicate different user devices, regardless of order or importance. For example, without departing from the scope of the rights set forth herein, a first component may be referred to as a second component, and similarly, a second component may be referred to as a first component.

When it is stated that a component (e.g., a first component) is “(operatively or communicatively) coupled with/to” or “connected to” to another component (e.g., a second component), it should be understood that the component may be connected directly to the other component, or through another component (e.g., a third component). On the other hand, when it is stated that a component (e.g., a first component) is “directly connected” or “directly connected” to another component (e.g., a second component), it may be understood that no other component (e.g., a third component) exists between that component and the other component.

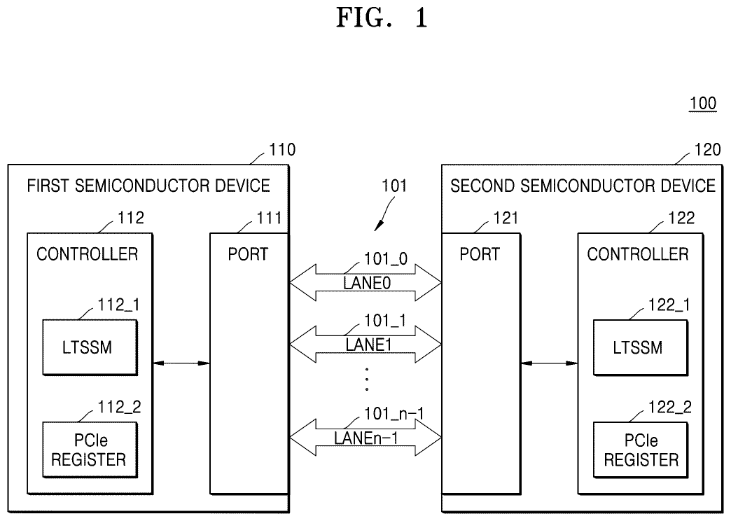

FIG. 1 is a block diagram illustrating a system 100 according to some example embodiments.

Referring to FIG. 1, the system 100 according to some example embodiments of the present inventive concepts may be an electronic device including a plurality of semiconductor devices. For example, the system 100 may include a smartphone, a tablet personal computer (PC), a mobile phone, an e-book reader, a desktop personal computer (PC), a laptop PC, a netbook computer (PDA), a personal digital assistant (PMP), an MP3 player, a mobile medical device, a camera, a wearable device, or a home appliance, but example embodiments are not limited thereto. The wearable device according to some example embodiments may include an accessory type (e.g., a watch, a ring, a bracelet, an anklet, a necklace, glasses, a contact lens, or a head-mounted-device (HMD), etc.), a fabric or clothing integral type (e.g., electronic clothing), a body attachment type (e.g., a skin pad or a tattoo), or a bio-implantable type (e.g., an implantable circuit), but example embodiments are not limited thereto. Home appliances according to some example embodiments may include, for example, a television, a digital video disk (DVD) player, an audio, a refrigerator, an air conditioner, a cleaner, an oven, a microwave, a washing machine, an air purifier, or a set-top box, but example embodiments are not limited thereto.

In some example embodiments, the system 100 may include a first semiconductor device 110 and a second semiconductor device 120. The first semiconductor device 110 and the second semiconductor device 120 may be communicatively connected to each other through a peripheral component interconnect express (PCIe) link 101. Each of the first semiconductor device 110 and the second semiconductor device 120 may transmit and receive a data packet through the PCIe link 101. In some example embodiments, one of the first semiconductor device 110 and the second semiconductor device 120 may be a host and the other may be a PCIe endpoint. For example, the first semiconductor device 110 may be a host, and the second semiconductor device 120 may be a PCIe endpoint. For example, the first semiconductor device 110 may be a PCIe endpoint, and the second semiconductor device 120 may be a host. The host may include a central processing unit (CPU), a root complex, etc. The PCIe endpoint may include a storage device such as a graphics card, a sound card, or a card-type solid-state drive or solid-state disk (SSD).

The data packet may be a packet based on a PCIe interface (or the PCIe standard). A PCIe is a connection terminal standard used for high-speed data transmission. The PCIe may have characteristics such as serial communication, one or more lanes, interactive communication, interchangeability, or versatility. For example, the data packet according to the PCIe interface may include a transaction layer packet (TLP), a data link layer packet (DLLP), various ordered sets, etc. The various ordered sets may include, for example, a skip ordered set (or “SKP”), a start of data stream (or “SDS”) ordered set, various training sequence (hereinafter referred to as “TS”) ordered sets (e.g., a TS0 ordered set, a TS1 ordered set, and a TS2 ordered set), an electrical idle ordered set (hereinafter referred to as “EIOS”), an electrical idle exit ordered set (hereinafter referred to as “EIEOS”), etc., but example embodiments are not limited thereto.

According to some example embodiments of the present inventive concepts, “one device transmits or sends and receives a data packet” may mean “one device transmits or sends a data packet to another device” and/or “one device receives a data packet from another device”. According to some example embodiments of the present inventive concepts, “one device transmits or sends and receives a plurality of data packets” may mean, for example, “one device transmits or sends and receives the same data packet (e.g., first data packet)”, “one device transmits or sends one data packet to another device, and receives a second data packet from another device”, and/or “one device transmits or sends the second data packet to another device and receives the first data packet from another device”.

The PCIe link 101 may include a plurality of lanes 101_0, 101_1, . . . , 101_n−1. The number of lanes may be n, n may be 2^{k}, and k may be an integer greater than or equal to 0. For example, the PCIe link 101 may include one, two, four, eight, or sixteen lanes. Hereinafter, for convenience of description, it is assumed that the PCIe link 101 includes four lanes (e.g., first to fourth lanes 101_0, 101_1, 101_2, and 101_3).

Each of the first semiconductor device 110 and the second semiconductor device 120 may include a port and a controller. For example, the first semiconductor device 110 may include a port 111 and a controller 112, and the second semiconductor device 120 may include a port 121 and a controller 122. In some example embodiments, a port of a semiconductor device implemented as a host may be referred to as a “downstream port”, and a port of a semiconductor device implemented as a PCIe endpoint may be referred to as an “upstream port”. For example, when the first semiconductor device 110 is a host and the second semiconductor device 120 is a storage device, the port 111 may be a “downstream port” and the port 121 may be an “upstream port”. However, example embodiments of the present inventive concepts are not limited to the above-described example embodiments, and the port 111 may be an “upstream port”, and the port 121 may be a “downstream port”.

The ports 111 and 121 may be connected to each other through the PCIe link 101. The ports 111 and 121 may transmit or send data packets through the plurality of lanes 101_0, 101_1, . . . , 101_n−1 of the PCIe link 101, and may provide the data packets received through the plurality of lanes 101_0, 101_1, . . . , 101_n−1 to the controllers 112 and 122.

In some example embodiments, when the data packet includes a TLP and/or a DLLP, each of a plurality of symbols of the TLP and/or the DLL may be transmitted or sent and received through each of the plurality of lanes 101_0, 101_1, . . . , 101_n−1. For example, when the number of lanes is four, and when the number of symbols of the TLP and/or the DLL is five, a first symbol may be transmitted or sent through the first lane 101_0, a second symbol may be transmitted or sent through the second lane 101_1, a third symbol may be transmitted or sent through the third lane 101_2, a fourth symbol may be transmitted or sent through the fourth lane 101_3, and a fifth symbol may be transmitted or sent through the first lane 101_0. In this way, the symbols of the TLP and/or the DLLP may be sequentially transmitted or sent to the plurality of lanes 101_0, 101_1, . . . , 101_n−1 one by one.

In some example embodiments, when the data packet includes an ordered set such as a TS ordered set, ordered sets may be transmitted or sent and received to and from the plurality of lanes 101_0, 101_1, . . . , 101_n−1. For example, TS1 ordered sets may be transmitted or sent to the plurality of lanes 101_0, 101_1, . . . , 101_n−1.

Each of the ports 111 and 121 may include a transmitter and a receiver for each of the plurality of lanes 101_0, 101_1, . . . , 101_n−1. For example, each of the ports 111 and 121 may include a transmitter and a receiver included in the first lane 101_0, the transmitter of the port 111 and the receiver of the port 121 may be connected to each other, and the receiver of the port 111 and the transmitter of the port 121 may be connected to each other. Each of the other lanes 101_1 to 101_n−1 may also include a transmitter and a receiver in each of the ports 111 and 121. A signal transmitted or sent between a transmitter of one port and a receiver of another port may be a differential signal.

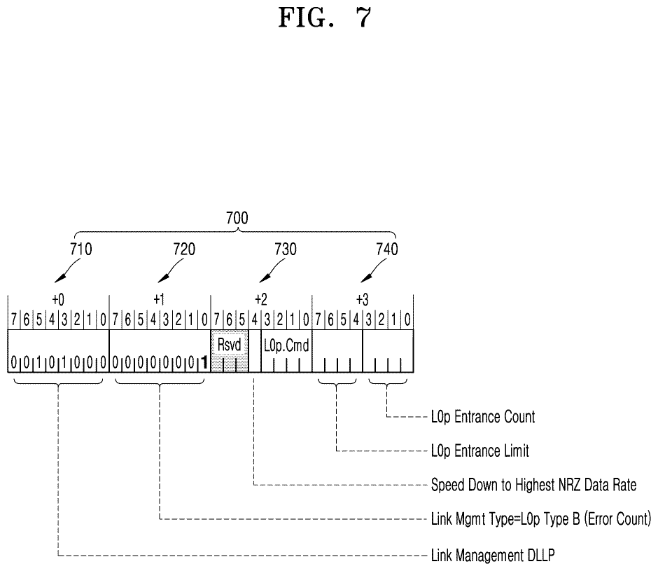

In some embodiments, the ports 111 and 121 may transceive DLLPs in an L0 state of the PCIe. The L0 state of the PCIe may be an enterable communication state in a state in which a link TS is normally completed. In some example embodiments, the DLLP may be a link management DLLP to be described below with reference to FIG. 7. The DLLP according to some example embodiments may include a DLLP type field, a link management type field, a speed down field, an L0p command field, an L0p entry count field, and an L0p entry limit field.

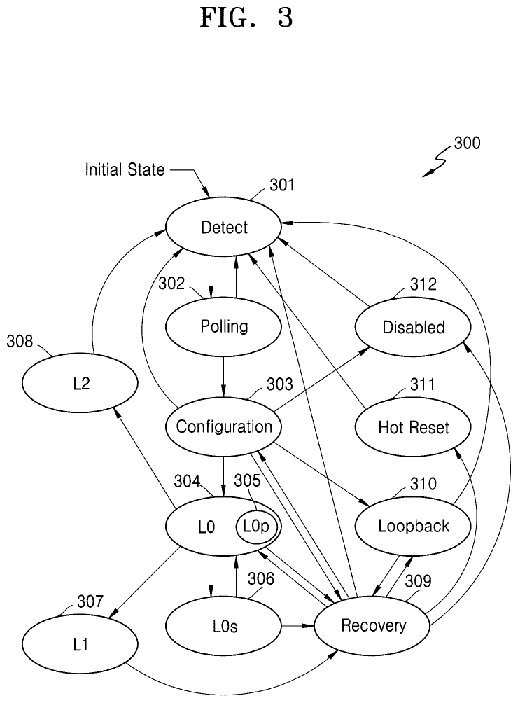

The controllers 112 and 122 may generate data packets and provide the generated data packets to the ports 111 and 121. The controllers 112 and 122 may process the data packets received from the ports 111 and 121. In some example embodiments, each of the controllers 112 and 122 may include an LTSSM and a PCIe register. For example, the controller 112 may include an LTSSM 112_1 and a PCIe register 112_2, and the controller 122 may include an LTSSM 122_1 and a PCIe register 122_2. The LTSSMs 112_1 and 122_1 may be state machines for exchanging and controlling state information of the PCIe link 101. The LTSSMs 112_1 and 122_1 may include a plurality of states in charge of various link operations. The plurality of states of the LTSSMS 112_1 and 122_1 will be described below with reference to FIG. 3 according to some example embodiments. The PCIe register 112_2 may store the state information of the PCIe link 101. For example, the PCIe register 112_2 may store a link speed, a link width, the number of transitions, the maximum number of transitions, etc., of the PCIe link 101. The link speed may be determined and calculated based on a data rate and an encoding/decoding method. The link width may correspond to the number of lanes. One controller (e.g., the controller 112) may obtain state information stored in the PCIe register 112_2 of another controller (e.g., the controller 122).

In some example embodiments, the controllers 112 and 122 may calculate a first bit error rate (hereinafter referred to as “BER”) of the data packet received through the PCIe link 101 in the L0 state of the PCIe. The controllers 112 and 122 may perform a communication operation of transceiving a DLLP through the PCIe link 101 based on the first BER and a first criterion value. The DLLP may include the number of transitions and the maximum number of transitions from the L0 state to an L0p state. The controllers 112 and 122 may determine to perform at least one of a link speed changing operation performed in a recovery state of the PCIe and a link width changing operation performed in the L0p state based on the number of transitions and the maximum transitions of the DLLP. The link speed changing operation may be an operation of reducing the link speed of the PCIe link 101. The link width changing operation may be an operation of reducing the link width of the PCIe link 101.

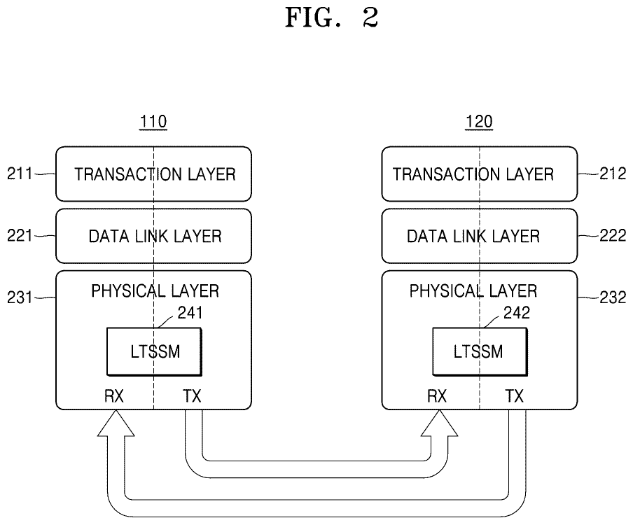

FIG. 2 is a layering diagram illustrating an interconnect architecture according to some example embodiments.

Referring to FIGS. 1 and 2, the first semiconductor device 110 and the second semiconductor device 120 may form a layered protocol stack according to the PCIe standard. For example, the first semiconductor device 110 may include a transaction layer 211, a data link layer 221, and a physical layer 231, and the second semiconductor device 120 may include a transaction layer 212, a data link layer 222, and a physical layer 232. The transaction layers 211 and 212, the data link layers 221 and 222, and the physical layers 231 and 232 may be included in the controllers 112 and 122 of the first semiconductor device 110 and the second semiconductor device 120.

Components (e.g., the first semiconductor device 110 and/or the second semiconductor device 120) that communicate according to the PCIe standard may use data packets to exchange information. The data packets may be generated in the transaction layers 211 and 212 and the data link layers 221 and 222, and the physical layers 231 and 232 may frame the data packets. The framed data packets may be transmitted or sent from a transmission (TX) component to a reception (RX) component.

Hereinafter, for convenience, it will be described as an example that the first semiconductor device 110 is a host, the second semiconductor device 120 is a storage device, and a data packet is transmitted or sent from the host to the storage device. For example, data packets may be generated in the transaction layer 211 and the data link layer 221 and transmitted or sent from the first semiconductor device 110 to the second semiconductor device 120. As data packets transmitted or sent from the transaction layer 211 of the first semiconductor device 110 pass through other layers, essential, or alternatively desired information for controlling the data packets in each of different layers may be added to further expand the data packets.

The second semiconductor device 120 may perform transformation on the data packets received from the first semiconductor device 110 so as to be interpreted in the physical layer 232 and the data link layer 222, and the transformed data packets may be processed in the transaction layer 212.

The transaction layers 211 and 212 may serve as interfaces between the core and the data link layers 221 and 222 that control components. For example, the transaction layer 211 may serve as an interface between the core in the controller 112 that controls the first semiconductor device 110 and the data link layer 221. For example, the transaction layer 212 may serve as an interface between the core in the controller 122 that controls the second semiconductor device 120 and the data link layer 222. The transaction layers 211 and 212 may serve to assemble or disassemble TLPs. The TLP may be a packet generated in the transaction layers 211 and 212 to transfer a request or a completion.

The data link layers 221 and 222 may serve as medium between the transaction layers 211 and 212 and the physical layers 231 and 232. The data link layers 221 and 222 may apply a reliable mechanism to the TLP that may be exchanged between the transaction layers 211 and 212 and the physical layers 231 and 232.

For example, the data link layer 221 receives assembled TLPs through the transaction layer 211. The data link layer 221 may apply a packet sequence identifier (e.g., an identification number or a packet number) to the TLPs received through the transaction layer 211. Thereafter, the data link layer 221 may apply an error detection code (e.g., cyclic redundancy checking (CRC)) to the TLPs to which the packet sequence identifier is applied. Thereafter, the data link layer 221 may transmit or send the modified TLPs to the physical layer 231, and the physical layer 231 may frame the modified TLPs and transmit or send the framed data packets to an external device (e.g., the second semiconductor device 120).

As some example embodiments, the data link layer 222 receives the assembled TLPs through the transaction layer 212. The data link layer 222 may apply the packet sequence identifier (e.g., the identification number or the packet number) to the TLPs received through the transaction layer 212. Thereafter, the data link layer 222 may apply the error detection code (e.g., CRC) to the TLPs to which the packet sequence identifier is applied. Thereafter, the data link layer 222 may transmit the modified TLPs to the physical layer 232, and the physical layer 232 may transmit or send the data packets received from the data link layer 222 to an external device (e.g., the first semiconductor device 110).

In some example embodiments, the data link layers 221 and 222 may generate DLLPs. The DLLP may be a packet generated to support link management functions.

Each of the physical layers 231 and 232 may include a logic sub-block and an electrical sub-block. The logic sub-block may be responsible for each of the physical layers 231 and 232 to perform a digital function. The logic sub-block may include a transmitter that prepares information emitted by the electrical sub-block. In some example embodiments, the logic sub-block may include a receiver that identifies the information received from the external device and prepares to transfer the information to each of the data link layers 221 and 222 before transferring the information received from the external device to each of the data link layers 221 and 222. In some example embodiments, in order to transceive the data packets between the first semiconductor device 110 and the second semiconductor device 120, a process (e.g., LTSSMs 241 and 242) of establishing a link may be performed. The LTSSMs 241 and 242 may be performed between logic sub-blocks.

FIG. 3 is a state diagram of a LTSSM 300 according to some example embodiments.

Referring to FIG. 3, the LTSSM 300 may provide a link-up process, which is a control process for configuring and initializing a link. In addition to configuration and initialization of the link in a PCIe interface, the LTSSM 300 may perform packet transmission support, link error recovery, a restart function of the PCIe interface in a low power state, etc. The LTSSM 300 may transition between a plurality of states 301 to 312 (for example, a detection state 301, a polling state 302, a configuration state 303, an L0 state 304, an L0p state 305, an L0s state 306, an L1 state 307, an L2 state 308, a recovery state 309, a loopback state 310, a hot reset state 311, and a disabled state 312) and may perform the above-described functions.

The LTSSM 300 may transition from an initial state to a detection state 301. In the detection state 301, the LTSSM 300 may detect the presence of an external device connected to the PCIe interface.

The LTSSM 300 may detect a receiver connected to a transmitter in the detection state 301 and may transition from the detection state 301 to a polling state 302. In the polling state 302, a generation version of a protocol (e.g., the PCIe interfaces) of connected devices (e.g., the first semiconductor devices 110 and the second semiconductor device 120) may be identified, and a data transmission rate may be determined based on the highest generation version compatible with each other. The LTSSM 300 may set a bit lock, a symbol lock, a block lock, or a lane polarity in the polling state 302. In some example embodiments, when a state transitions from the detection state 301 to the polling state 302, a lane in which the receiver is not detected may enter an electrical idle state.

In some example embodiments, when the state transitions from the polling state 302 to a configuration state 303, the LTSSM 300 may set a data rate, a lane number, and a link width in the configuration state 303. The link width may be the number of lanes of the PCIe link 101. When an operation in the configuration state 303 is completed, the LTSSM 300 may enter an L0 state 304. In the configuration state 303, general data communication may be interrupted.

In some example embodiments, according to an operation situation of the PCIe interface, the state may transition to an L0s state 306 which is the electrical idle state and/or a standby state, an L1 state 307 which is a low power standby state and/or a sleep state, or an L2 state 308 which is an off state.

In order to support a link width adjustment mechanism, in some example embodiments, the LTSSM 300 may further include an L0p state 305. The L0p state 305 may be a sub-state of the L0 state 304. The L0p state 305 may be a sub-state introduced from version 6.0 (also referred to as “Gen. 6”) of the PCIe standard to activate or deactivate a specific, or alternatively desired lane. For example, when one side of the semiconductor device intends to operate with a link width narrower than the maximum configured link width negotiated in the L0 state 304, the state may transition from the L0 state 304 to the L0p state 305. General data communication may continue in the L0p state 305. For example, in the L0p state 305, the PCIe link 101 may continue to be maintained in the same manner as in the L0p state 304, but in the L0p state 305, some lanes may be in the electrical idle state and the remaining lanes may be turned on. A phase locked loop (PLL) connected to a lane in the electrical idle state may also be turned off. The lane in the electrical idle state in the L0p state 305 may be turned on.

When an error occurs in the data packet while operating in the L0 state 304, the LTSSM 300 may enter a recovery state 309. In some example embodiments, in order to transition from the L1 state 307 to the L0 state 304, the LTSSM 300 may enter the recovery state 309. The recovery state 309 may have control functions such as recovering an error of the PCIe link 101 and changing the link speed. Gen. 6 of the PCIe standard stipulates a rule that when a host intends to change the link speed/link width in the L0 state 304, or when the host intends to enter (or transition) a specific, or alternatively desired state such as a loopback state 310, a hot reset state 311, or a disabled state 312, the LTSSM 300 preferentially enters the recovery state 309. In some example embodiments, when a fatal error occurs, the LTSSM 300 in the recovery state 309 may perform functions such as bit lock, symbol lock, and inter-lane skew removal based on data (e.g., TS1/TS2) such as a TS transceived between a transmitter and a receiver or change a link speed. In some example embodiments, when a less serious error occurs, the state may transition from the recovery state 309 to the L0 state 304. The recovery state 309 may include sub-states such as Recovery.RcvrLock, Recovery.Equalization, Recovery.Speed, Recovery.RcvrCfg, Recovery.Idle, etc. In some example embodiments, according to a result in the sub-state, the recovery state 309 may transition to the detection state 301, the configuration state 303, the L0 state 304, the loopback state 310, the hot reset state 311, or the disabled state 312. A conditional transition relationship may be defined between the sub-states of the recovery state 309. For example, when a certain, or alternatively desired condition is not satisfied for a certain, or alternatively desired period of time, a timeout may occur, which may force a transition from one sub-state of the recovery state 309 to a specific, or alternatively desired sub-state of the recovery state 309. In the case of a normal PCIe link 101, no timeout occurs.

In the loopback state 310, the LTSSM 300 may be used for test and fault isolation. In the hot reset state 311, the LTSSM 300 may perform a function of resetting a link (e.g., the PCIe link 101) through in-band signaling. In some example embodiments, when the LTSSM 300 deactivates the PCIe link 101, the LTSSM 300 may enter the disabled state 312.

In some example embodiments, in the link-up process constituting the link, the LTSSM 300 may perform the above-described functions by transitioning the plurality of states 301 to 312 in a certain, or alternatively desired order. According to some example embodiments, when a link-up is successful, the states in which the LTSSM 300 actually performed among the plurality of states 301 to 312 and the performing order thereof may be stored in an internal memory of a controller (e.g., the controllers 112 and 122) as a reference order until the link-up is successful.

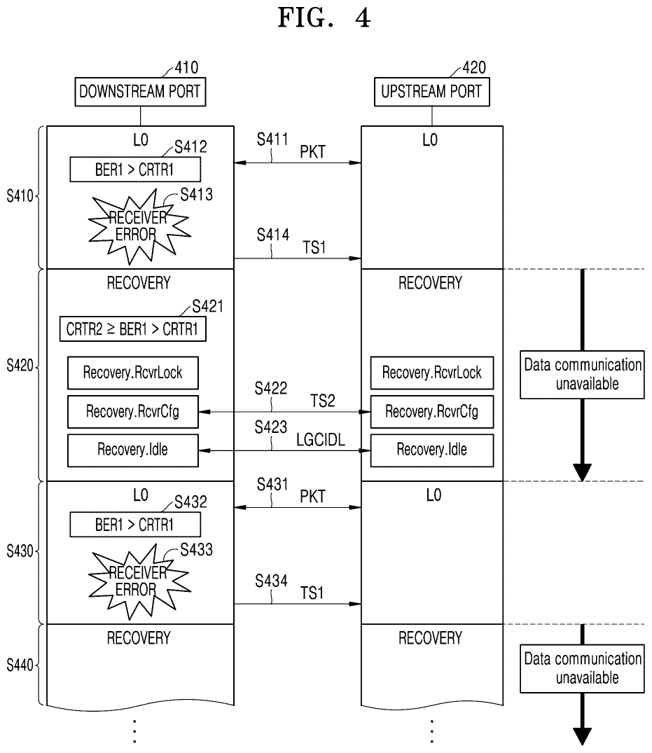

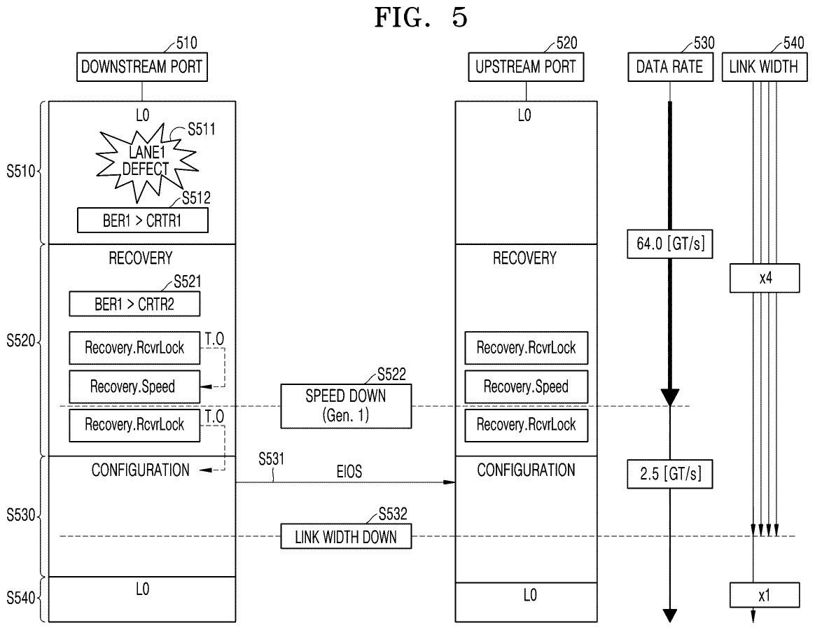

In some example embodiments, the first semiconductor device 110 and the second semiconductor device 120 communicating through the PCIe link 101 may transceive a specific, or alternatively desired type of packet (e.g., the ordered set), thereby exchanging information about the configuration and state of the PCIe link 101, configuring the PCIe link 101 according to the LTSSM rule, and performing communication. In some example embodiments, because the LTSSM rule is applied without exception to semiconductor devices that communicate through the PCIe interface, due to various exceptional or example situations and errors that may occur in an actual mounting environment, an operation based on the LTSSM rule according to the existing PCIe standard may cause unnecessary or increased performance degradation. Hereinafter, an exceptional or example situation in which performance is reduced or unnecessarily degraded will be described with reference to FIGS. 4 and 5.

FIG. 4 is a diagram illustrating a comparative example in which the L0 state 304 and the recovery state 309 repeatedly transition according to some example embodiments.

Referring to FIGS. 1, 3, and 4, in some example embodiments, a downstream port 410 may be a port included in a semiconductor device of a high level such as a host, and an upstream port 420 may be a port included in a semiconductor device of a low level such as a PCIe endpoint. Referring to FIG. 1, for example, when the first semiconductor device 110 is a host and the second semiconductor device 120 is a storage device, the downstream port 410 may be the port 111 of the first semiconductor device 110, and the upstream port 420 may be the port 121 of the second semiconductor device 120. However, example embodiments of the present inventive concepts are not limited thereto, and in some example embodiments of the present inventive concepts, the downstream port 410 may be the port 121, and the upstream port 420 may be the port 121. The operation of the downstream port 410 described below according to some example embodiments may be the same as the operation of the host, and the operation of the upstream port 420 may be the same as the operation of the PCIe endpoint.

The downstream port 410 and the upstream port 420 may enter the L0 state 304 (S410). In the L0 state 304, the downstream port 410 and the upstream port 420 may perform a communication operation S411 of transceiving a packet PKT. The packet PKT may correspond to the TLP described above according to some example embodiments. In some example embodiments, the downstream port 410 may calculate a first BER BER1 based on the packet PKT received from the upstream port 420, and may determine whether to transition from the L0 state 304 to the recovery state 309 based on the first BER BER1 and a first criterion value CRTR1. The state from the L0 state 304 to the recovery state 309 may transition by a number of errors in a receiver of the downstream port 410 unless the host has any intention. For example, when the first BER BER1 exceeds or is greater than the first criterion value CRTR1 (S412), the downstream port 410 may determine that a receiver error has occurred (S413), enter the recovery state 309, and transmit the TS ordered set 1 TS1 to the upstream port 420 (S414), thereby allowing the upstream port 420 to induce the state transition of the recovery state 309. The upstream port 420 may enter the recovery state 309 in response to the TS ordered set 1 TS1. The first criterion value CRTR1 may be, for example, 10⁽⁻¹²⁾, but example embodiments of the present inventive concepts are not limited to thereto.

In some example embodiments, when the current state transitions from the L0 state 304 to the recovery state 309 (S420), data communication may be unavailable (see, e.g., “data communication unavailable” of FIG. 4), and a second criterion value CRTR2 applied in the recovery state 309 may be applied as a more relaxed value than the first criterion value CRTR1. For example, in some example embodiments, the second criterion value CRTR2 may be greater than the first criterion value CRTR1. For example, the first criterion value CRTR1 may be 10⁽⁻¹²⁾, and the second criterion value CRTR2 may be 10⁽⁻⁴⁾, but example embodiments of the present inventive concepts are not limited thereto. In some example embodiments, when the first BER BER1 is greater than the first criterion value CRTR1 and less than or equal to the second criterion value CRTR2 (S421), a function may not be performed and the normal packet PKT may be received in the recovery state 309, and accordingly, in some example embodiments, a timeout does not occur in the recovery state 309 and a general state transition is performed. For example, the state may be restored from the recovery state 309 to the L0 state 304. For example, when the first BER BER1 falls within a range between the first criterion value CRTR1 and the second criterion value CRTR2 (S421), the L0 state 304 may transition to a Recovery.RcvrLock sub-state, and the Recovery.RcvrLock sub-state may transition to a Recovery.RcvrCfg sub-state. In some example embodiments, in the Recovery.RcvrCfg sub-state, the downstream port 410 and the upstream port 420 may perform a communication operation S422 of transceiving the TS ordered set TS2. Thereafter, the Recovery. RcvrCfg sub-state transitions to a Recovery.Idle sub-state, and the downstream port 410 and the upstream port 420 may perform a communication operation S423 of transceiving logical idle LGCIDL in the Recovery.Idle sub-state. Thereafter, according to some example embodiments, the Recovery. Idle sub-state may transition to the L0 state 304.

In some example embodiments, when the state is restored from the recovery state 309 to the L0 state 304 (S430), the first criterion value CRTR1 in the L0 state 304 is applied as described above (e.g., in S410) according to some example embodiments. Accordingly, because the first BER BER1 exceeds the first criterion value CRTR1 (S432), the downstream port 410 determines that the receiver error has occurred (S433), enters the recovery state 309, and transmits or sends the TS ordered set 1 TS1 to the upstream port 420 (S434), thereby allowing the upstream port 420 to induce the state transition of the recovery state 309.

In operation S440, the same situation as in operation S420 occurs, and as a result, the entry of each of the L0 state 304 and the recovery state 309 is repeated without any improvement. Eventually, the L0 state 304 may be superficially restored without problems, but the receiver error corresponding to the first BER BER1 still exceeding the first criterion value CRTR1 occurs in the L0 state 304. Due to the characteristics of the PCIe link 101 in which data communication may not be performed in the recovery state 309, continuity of data communication may be lost as the entry of the recovery state 309 is repeated, which may cause the performance of the system 100 to reduce or deteriorate.

While, the comparative example of FIG. 4 has been described with respect to the downstream port 410 in FIG. 4 according to some example embodiments, the upstream port 420 may also perform the operations as described above.

According to the comparative example, a situation in which the L0 state 304 is restored after the entry of the recovery state 309 and a situation in which the L0 state 304 is maintained without the entry of the recovery state 309 are not distinguished by protocol. Accordingly, it may be advantageous to provide for an operation or operational method of stipulating an event in which the state returns to the L0 state 304 without substantial improvement of an error (e.g., receiver error) of the PCIe link 101 as described above in the PCIe interface and/or the PCIe standard, including information of the above-described event in a data communication target, and allowing or enabling the system 100 to improve the error of the PCIe link 101 based on the information.

FIG. 5 is a diagram for explaining a comparative example in which a link speed is reduced before reducing a link width according to some example embodiments. A description of the comparative example shown in FIG. 5 which is redundant with that given with reference to FIG. 4 is omitted. In addition, for convenience of explanation, it is assumed that the number of lanes of the PCIe link 101 is four, among first to fourth lanes included in the PCIe link 101, the first lane may be “LANE0” of FIG. 1, the second lane may be “LANE1” of FIG. 1, the third lane may be “LANE2” of FIG. 1, and the fourth lane may be “LANE3” of FIG. 1.

Referring to FIGS. 1, 3, 4, and 5, a downstream port 510 and an upstream port 520 enter the L0 state 304 (S510), and transceive packets (e.g., “PKT” illustrated in FIG. 4). At this time, a data rate 530 may be a maximum data rate supported by GEN. 6 of the PCIe standard, for example, 64.0 [GT/s]. However, example embodiments of the present inventive concepts are not limited thereto, and the data rate 530 may be a maximum data rate supported by a higher version than GEN. 6 of the PCIe standard. Referring to FIG. 4, a link width 540 may be “Linkwidth=x4”. “Linkwidth=x4” may mean that the number of activated lanes is four. However, example embodiments of the present inventive concepts are not limited thereto. Unlike FIG. 4, a defect may occur in any one of the first to fourth lanes of the PCIe link 101. For example, a defect in the lane may be that an unrecoverable error occurs in the lane even by a function of improving the characteristics of a signal in the recovery state 309. Referring to FIGS. 1 and 5, for example, the defect may occur in the second lane “LANE1” (S511). However, example embodiments of the present inventive concepts are not limited thereto. In some example embodiments, the first BER BER1 calculated in the L0 state 304 may exceed the first criterion value CRTR1 due to a defect in the second lane (S512). For example, it would be advantageous to exclude the defective lane from a data communication operation.

However, the LTSSM rule of GEN. 6 of the PCIe standard according to the comparative example may perform operations of recovering errors according to a consistent priority. For example, the LTSSM rule of GEN. 6 of the PCIe standard according to the comparative example may perform an operation of reducing a link speed in the recovery state 309 at a first priority and may perform an operation of reducing a link width at a second priority to exclude the defective lane from a data communication operation in the configuration state 303.

For example, as the first BER BER1 exceeds (e.g., is greater than) the first criterion value CRTR1 (S512), the downstream port 510 and the upstream port 520 may enter the recovery state 309 from the L0 state 304 (S520). In the recovery state 309, the first BER BER1 may exceed (e.g., is greater than) the second criterion value CRTR2 (S521). In some example embodiments, the downstream port 510 may not normally receive the packet. Thus, a certain transition condition may not be satisfied in a Recovery. RcvrLock sub-state and a timeout T.O occurs. The time for the timeout T.O. to occur is 24 [ms]. Because the operation of reducing the link speed is performed first, the Recovery. RcvrLock sub-state transitions to a Recovery.Speed sub-state. In the Recovery.Speed sub-state, a data rate is reduced to a preset, or alternatively desired data rate (S522). For example, the preset, or alternatively desired data rate is 2.5 [GT/s] which is the maximum supported data rate in the version 1.0 (also referred to as “Gen. 1”) of the PCIe standard. After the data rate is reduced, the Recovery.Speed sub-state transitions to the Recovery.RcvrLock sub-state, and even when the data rate is reduced, the defect in the second lane is still not improved, the timeout T.O occurs, and the Recovery.RcvrLock sub-state transitions to the configuration state 303 (S530).

In some example embodiments, in the configuration state 303, the downstream port 510 may transmit or send an electrical idle ordered set (EIOS) to the upstream port 520 with respect to at least one lane according to a predetermined, or alternatively desired lane idle order and the number of lane idles until the error is improved (S531). In some example embodiments, a transmitter in a lane where the EIOS is received may be changed to an electrical idle state. According to the PCIe standard, the number of lanes to be activated may be j-square of 2. j may be an integer greater than or equal to 0. For example, the number of cases or instances of activating the first to fourth lanes may be three. At this time, for example, only the first lane and the second lane may be activated in a case or instance where two lanes are activated, and only the first lane may be activated in a case or instance where one lane is activated.

Referring to FIG. 5, for example, because the defect has occurred in the second lane, only the first lane may be activated. For example, the downstream port 510 may transmit or send the EIOS to the upstream port 520 with respect to the third and fourth lanes, and change a state of a transmitter of each of the third and fourth lanes to the electrical idle state. In some example embodiments, because the error may not be improved, the downstream port 510 may transmit or send the EIOS to the upstream port 520 with respect to the second lane and change a state of a transmitter of the second lane to the electrical idle state. As a result, only the first lane may be activated. The link width is reduced so that the error is improved (S532), and the reduced link width is “linkwidth=x1”.

Unlike FIG. 5, in some example embodiments, when a defect occurs in the third lane or the fourth lane, the first lane and the second lane may be activated, and the reduced link width may be “linkwidth=x2”.

The configuration state 303 transitions to the L0 state 304 (S540). In the L0 state 304, the PCIe link 101 operates as “linkwidth=x1” in Gen. 1 of the PCIe standard. In Gen. 6 of the PCIe standard, the link speed when the PCIe link 101 operates as “linkwidth=x4” is 8 [GB/s] (8 [GB/s]=64.0 [GT/s]=8 (bits)=1×1 (e.g., following the encoding/decoding method in Gen. 6 of the PCIe standard), whereas in Gen. 1 of the PCIe standard, the link speed when the PCIe link 101 operates as “linkwidth=x1” is 0.25 [GB/s] (0.25 [GB/s]=2.5 [GT/s]=8 (bits)=10×8 (e.g., following the encoding/decoding method in Gen. 1 of the PCIe standard). Therefore, according to the comparative example, the performance may be reduced, low, or very low.

Accordingly, in some example embodiments, because the transition order and priority of states after timeout T.O. occurs are stipulated in the LTSSM rule (e.g., an operation of reducing the link speed in the recovery state 309 has priority over an operation of reducing the link width in the configuration state 303), it may be advantageous to provide a separate LTSSM flow and/or operation to reduce the link width without reducing the link speed while following the LTSSM rule.

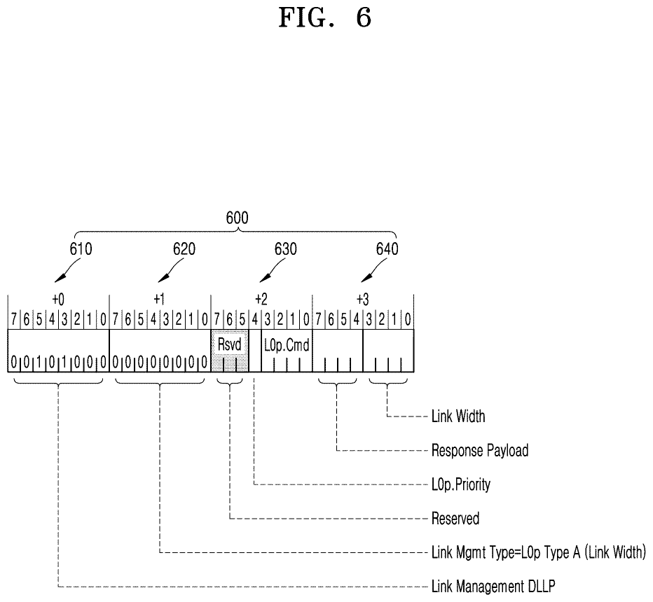

FIGS. 6 and 7 are diagrams illustrating a format of each of link management DLLPs 600 and 700 according to some example embodiments.

Referring to FIGS. 6 and 7, a DLLP according to some example embodiments may include a plurality of fields. The DLLP according to some example embodiments may be a link management DLLP of 4 bytes. The number of types of link management DLLPs may be plural. For example, the link management DLLP may include a first type of the link management DLLP 600 shown in FIG. 6 and a second type of the link management DLLP 700 shown in FIG. 7.

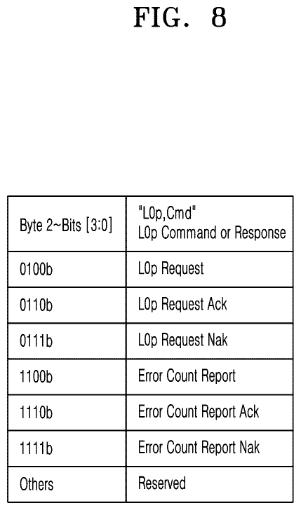

Referring to FIG. 6, in some example embodiments, a first byte 610 of the link management DLLP 600 may include a DLLP type field. When a value of the first byte 610 is ‘0010 1000b’, the DLLP type field may indicate a link management DLLP. A second byte 620 of the link management DLLP 600 may include a link management type field. The link management type field may indicate a specific, or alternatively desired type among a plurality of types of link management. Referring to FIG. 6, for example, when a value of the second byte 620 of the link management DLLP 600 is “0000 0000b”, the link management type field may indicate an L0p DLLP or a first type indicating a link width. For example, the first type may be referred to as “L0p Type A”. A third byte 630 of the link management DLLP 600 may include an L0p priority field and an L0p command field. The L0p priority field indicates an L0p priority request, and the L0p priority request may be changed by a value of the L0p command field. For example, [7:5] bits of the third byte 630 may be reserved, [4] bits of the third byte 630 may indicate an L0p priority, and [3:0] bits of the third byte 630 may indicate an L0p command or an L0p response. In some example embodiments, when a value of the [4] bit of the third byte 630 is “0b”, the L0p priority field may indicate a normal priority L0p request, and when the value of the [4] bit of the third byte 630 is “1b”, the L0p priority field may indicate a high priority L0p request. The L0p command field may include an L0p request, an L0p request ack, an L0p request nak, etc. In some example embodiments, ack stands for “acknowledgement”, and nak stands for “negative acknowledgement”. The L0p request is included in the L0p command, and the L0p request ack and the L0p request nak are included in the L0p response. The L0p command field will be described below with reference to FIG. 8 according to some example embodiments. The fourth byte 640 of the link management DLLP 600 may include a response payload field and/or a link width field. For example, [7:4] bits of the fourth byte 640 may indicate a response payload, and [3:0] bits of the fourth byte 640 may indicate a link width. The response payload may reflect a value of an L0p link width in response to the command. For example, when the L0p command field indicates a request (e.g., the L0p request ack or the L0p request nak), values of [7:4] bits of the fourth byte 640 may be “0001b”, “0010b”, “0100b”, “1000b”, or “0000b”. At this time, for example, “0001b” indicates that the link width is “x1”, “0010b” indicates that the link width is “x2”, “0100b” indicates that the link width is “x4”, “1000b” indicates that the link width is “x8”, and “0000b” indicates that the link width is “x16”. For example, when the L0p command field indicates the L0p request, values of [3:0] bits of the fourth byte 640 may be “0001b”, “0010b”, “0100b”, “1000b”, or “0000b”. At this time, for example, “0001b”, “0010b”, “0100b”, “1000b”, or “0000b” are the same as the meaning of the values of the [7:4] bits of the fourth byte 640 described above.

Referring to FIG. 7, in some example embodiments, a first byte 710 of the link management DLLP 700 may include a DLLP type field indicating a link management DLLP, and a value of the first byte 710 may be “0010 1000b”.

A second byte 720 of the link management DLLP 700 may include a link management type field. For example, when a value of the second byte 720 is “0000 0001b”, the link management type field may indicate a second type indicating an error count. The second type may be referred to as “L0p Type B”. The error count may mean a number of times of entry or transition to the L0p state 305. A third byte 730 of the link management DLLP 700 may include a speed down field and an L0p command field. The speed down field may include a value indicating whether a link speed is down. For example, when a value of [4] bit of the third byte 730 is “1b”, it may be confirmed that a counterpart port receiving the link management DLLP 700 will reduce the link speed. The value of [4] bit of the third byte 730 may be “0b” in the same meaning as reserved. In some example embodiments, when the value of [4] bit of the third byte 730 is “1b”, the speed down field may indicate that the link speed is reduced to a maximum supported data rate of the PCIe standard version following a highest non return to zero (NRZ). The encoding/decoding method and modulation method of versions of the PCIe standard may be different. For example, the encoding/decoding methods in Gen. 1 and Gen. 2 of the PCIe standard are 8b/10b, the encoding/decoding methods in Gen. 3 to Gen. 5 are 128b/130b, and the encoding/decoding methods in Gen. 6 of the PCIe standard are 1b/1b. Meanwhile, the modulation methods in Gen. 1 to Gen. 5 of the PCIe standard are NRZ, while the modulation method in Gen. 6 of the PCIe standard is four-level pulse amplitude modulation (PAM4).

In some example embodiments, when Gen. 6 or more versions different from Gen. 1 to Gen. 5 methods (e.g., encoding/decoding methods and/or modulation methods) are applied to the PCIe link 101 according to some example embodiments of the present inventive concepts, the link speed may indicate that the data rate is changed to the maximum supported data rate of Gen. 5 of the PCIe standard when the value of [4] bit of the third byte 730 is “1b”. According to some example embodiments, it may be assumed that the PCIe link 101 of the system 100 is Gen. 6 of the PCIe standard. At this time, for example, when the value of [4] bit of the third byte 730 is “0b”, the maximum data rate of the PCIe link 101 of the system 100 may be 64.0 [GT/s]. In some example embodiments, when the value of [4] bit of the third byte 730 is “1b”, the maximum data rate of the PCIe link 101 of the system 100 may be a data rate. e.g., 32.0 [GT/s], of a version (e.g., Gen. 5) supporting the highest data rate among lower versions (e.g., Gen. 1 to Gen. 5) of the NRZ method.

In some example embodiments, a fourth byte 740 of the link management DLLP 700 may include an L0p entry limit field and an L0p entry count field. For example, [7:4] bits of the fourth byte 740 may be the L0p entry limit field indicating the maximum number of times of transition, and [3:0] bits of the fourth byte 740 may be the L0p entry count field indicating the number of times of transitions. In some example embodiments, the number of times of transition is the number of times a state transitions (or enters) to the L0p state 305. The maximum number of times of transition is the maximum value of the number of times of transition.

According to some of the above-described example embodiments, by changing the link width without changing the link speed by utilizing the L0p state 305, there is an effect of improving the performance of the system 100 while following the LTSSM rule that an operation of reducing the link speed in the recovery state 309 precedes an operation of reducing the link width in the configuration state 303, and maintaining a high or relatively high performance of the system 100.

According to some example embodiments, there is the effect of improving or ensuring backward compatibility of the existing PCIe standard by performing an operation of improving an error in the recovery state 309 according to the existing PCIe standard, in addition to the operation of changing the link width performed in the L0p state 305.

FIG. 8 is a diagram for explaining an L0p command field of the link management DLLPs 600 and 700 according to some example embodiments.

Referring to FIGS. 7 and 8, the L0p command field may include an L0p request, an L0p request ack, an L0p request nak, an error count report, an error count report ack, an error count and an error count report nak. When a value of [3:0] bits of the third bytes 630 and 730 is “0100b”, the L0p command field may indicate the L0p request. When the value of [3:0] bits of the third bytes 630 and 730 is “0110b”, the L0p command field may indicate the L0p request ack. When the value of [3:0] bits of the third bytes 630 and 730 is “0111b”, the L0p command field may indicate the L0p request nak. When the value of [3:0] bits of the third bytes 630 and 730 is “1100b”, the L0p command field may indicate the error count report. The error count report may be a command for requesting that the number of times of transition be provided to a port of the other side or a semiconductor device of the other side. When the value of [3:0] bits of the third bytes 630 and 730 is “1110b”, the L0p command field may indicate the error count report ack. When the value of [3:0] bits of the third bytes 630 and 730 is “1111b”, the L0p command field may indicate the L0p request nak.

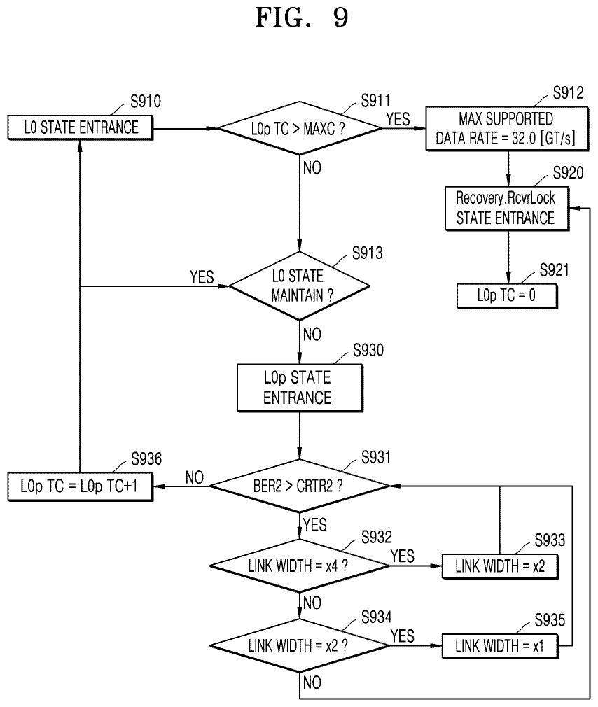

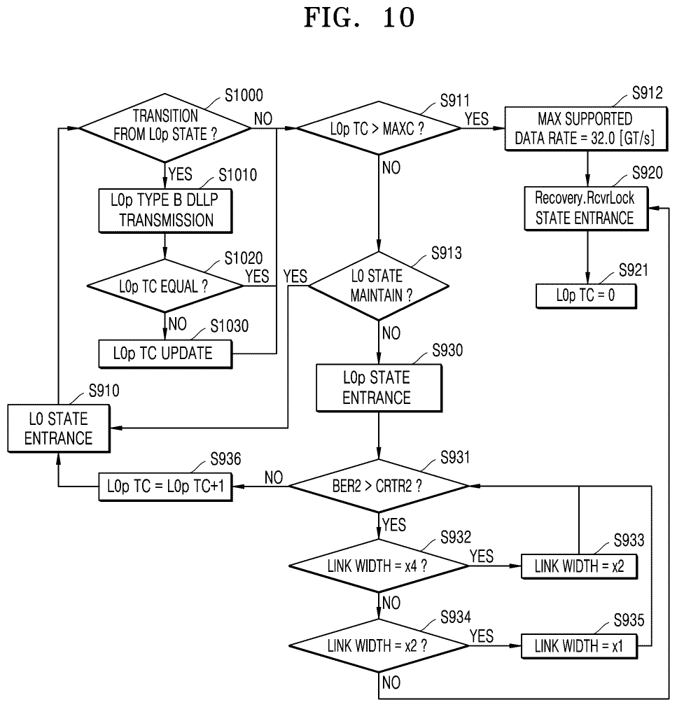

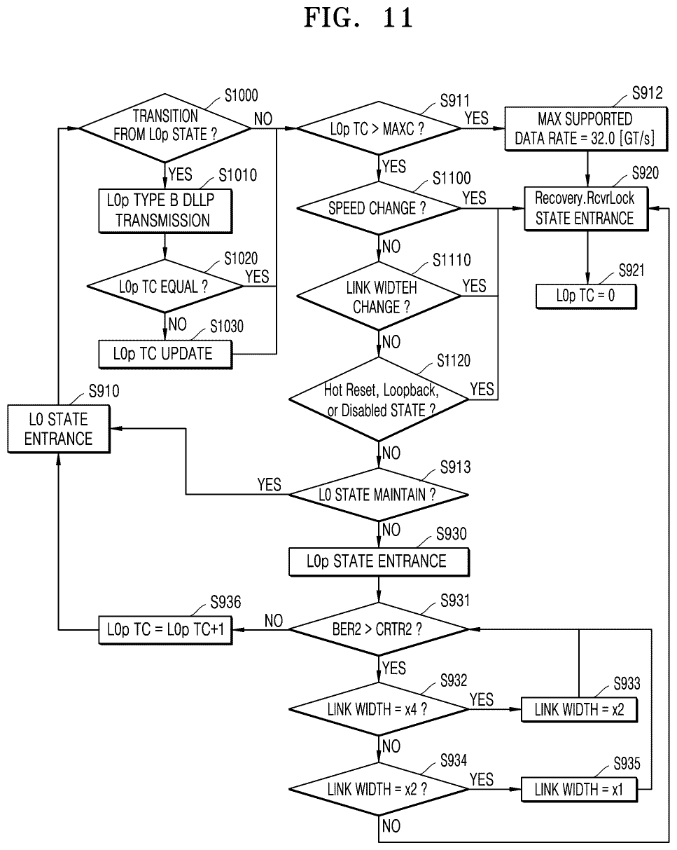

FIGS. 9, 10, and 11 are flowcharts illustrating operations of a semiconductor device according to some example embodiments. Some example embodiments of FIGS. 9 and 10 may be applied to a PCIe endpoint, for example, a storage device, and Some example embodiments of FIG. 11 may be applied to a host.

Referring to FIGS. 3 and 9, in some example embodiments, the PCIe endpoint may enter the L0 state 304 (S910). The PCIe endpoint may determine whether the number of times of L0p transition L0p TC exceeds the maximum number of times of transition MAXC (S911). The number of times of L0p transition L0p TC may be simply referred to as the number of times of transition as described above according to some example embodiments.

When the number of times of L0p transition L0p TC exceeds the maximum number of times of transition MAXC, the PCIe endpoint may generate a value notifying or indicating that a maximum supported data rate is set to a data rate (e.g., 32.0 [GT/s]) of Gen. 5 of the PCIe standard (S912). The PCIe endpoint may enter the Recovery. RcvrLock sub-state from the L0 state 304 (S920). In some embodiments, a controller of the PCIe endpoint may generate a value notifying or indicating that a link speed will be changed based on the number of times of L0p transition L0p TC greater than the maximum number of times of transition MAXC, and may transceive a first DLLP including the generated value through PCIe link 101. In some example embodiments, the Recovery.RcvrLock sub-state may transition to the Recovery.Speed sub-state, and the controller of the PCIe endpoint in the Recovery.Speed sub-state may reduce the link speed from 64.0 [GT/s] (or higher) to 32.0 [GT/s]. The PCIe endpoint may initialize the number of times of L0p transition L0p TC to “0” (S921). In some example embodiments, the controller of the PCIe endpoint may transition from the L0 state 304 to the recovery state 309 after the first DLLP is generated. In some example embodiments, the controller of the PCIe endpoint may transmit or send a TS ordered set including a value indicating a lower link speed than the current link speed to another controller in the recovery state 309, change the link speed to the lower link speed, and initialize the number of times of transitions. In some example embodiments, after the link speed is reduced, the controller of the PCIe endpoint may transition from the recovery state 309 to the L0 state 304.

When the number of times of L0p transition L0p TC is less than or equal to the maximum number of times of transition MAXC, the PCIe endpoint may determine whether the L0 state 304 may be maintained (S913). In some example embodiments, the controller of the PCIe endpoint may determine whether the L0 state 304 may be maintained by determining whether the first BER BER1 is less than or equal to the first criterion value CRTR1 in the L0 state 304. When the first BER BER1 is less than or equal to the first criterion value CRTR1, the L0 state 304 may be maintained, and operation S910 is performed.

When the first BER BER1 exceeds the first criterion value CRTR1, the L0 state 304 may not be maintained, and the PCIe endpoint may enter the L0p state 305 from the L0 state 304 (S930). In some example embodiments, the controller of the PCIe endpoint may transition from the L0 state 304 to the L0p state 305 based on the number of times of L0p transition L0p TC less than or equal to the maximum number of times of transition MAXC. The PCIe endpoint may determine whether the second BER BER2 in the L0p state 305 exceeds the second criterion value CRTR2 (S931). As described above, in some example embodiments, the second criterion value CRTR2 may be a criterion value applied in the recovery state 309.

When the second BER BER2 exceeds the second criterion value CRTR2, in some example embodiments, the controller of the PCIe endpoint may transmit EIOS to the other controller through the PCIe link 101 with respect to at least one target lane selected according to a predetermined, or alternatively desired lane idle order and the number of lane idles among a plurality of lanes (e.g., four lanes) based on the second BER BER2 greater than the second criterion value CRTR2 in the L0p state 305. The predetermined, or alternatively desired lane idle order and the number of lane idles according to some example embodiments may bring the lanes into an electrical idle state in order of highest lane numbers and halve the number of lanes to be activated. Four lanes are used, for example, in a example in which first to fourth lanes are activated, a example in which third and fourth lanes are deactivated or idle, and first and second lanes are activated, or an example in which only the first lane is activated. Eight lanes are used, for example, in an example in which first to eighth lanes are activated, and examples for four lanes. Similarly, sixteen lanes are used, for example, in an example in which first to sixteenth lanes are activated, and examples for eight lanes.

For example, the PCIe endpoint confirms whether the current link width is “x4” (S932). When the current link width is “x4”, the PCIe endpoint may change the current link width from “x4” to “x2” by outputting EIOS with respect to the third and fourth lanes in the L0p state 305 and bring transmitters of the third and fourth lanes into the electrical idle state (S933). Subsequently, operation S931 is performed. In operation S932, when the current link width is not “x4”, the PCIe endpoint confirms whether the current link width is “x2” (S934). When the current link width is “x2”, the PCIe endpoint may change the current link width from “x2” to “x1” by outputting EIOS with respect to the second lane in the L0p state 305 and bring a transmitter of the second lane into the electrical idle state (S935). Subsequently, operation S931 is performed. When the current link width is not “x2” in operation S934, operation S920 is performed. The BER may be calculated in operation S931 performed after operation S933 and/or operation S935, and the BER at this time may be referred to as a third BER, a fourth BER, etc.

In some example embodiments, when the second BER BER2 is less than or equal to the second criterion value CRTR2, the PCIe endpoint may increase the number of times of L0p transition L0p TC by one (S936). In some example embodiments, when the second BER BER2 is less than or equal to the second criterion value CRTR2, or when a third BER less than or equal to the second criterion value CRTR2 occurs after the link width is reduced, the controller of the PCIe endpoint may increase the number of times of L0p transition L0p TC by one without any further change in the link width based on the second BER BER2 or the third BER in the L0p state 305. After the number of times of L0p transition L0p TC increases, the controller of the PCIe endpoint may transition from the L0p state 305 to the L0 state 304.

Referring to FIGS. 3 and 10, in some example embodiments FIG. 10 may further include operations S1000, S1010, S1020, and S1030 in the operating method of FIG. 9. The PCIe endpoint may determine whether the L0 state 304 transitions from the L0p state 305 (S1000). When the L0 state 304 is shifted from the L0p state 305, the PCIe endpoint may transceive an L0p type B DLLP to and from another semiconductor device (S1010). The L0p type B DLLP may be the link management DLLP described above with reference to FIG. 7 according to some example embodiments. The PCIe endpoint may determine whether the number of times of L0p transition L0p TC stored therein and the number of times of L0p transition L0p TC included in the L0p type B DLLP received from the other semiconductor device are the same (S1020). For example, when the stored number of times of L0p transition L0p TC and the received number of times of L0p transition L0p TC are the same, operation S911 is performed. When the stored number of times of L0p transition L0p TC and the received number of times of L0p transition L0p TC are different, the PCIe endpoint may update the number of times of L0p transition L0p TC (S1030). For example, the controller of the PCIe endpoint may update a higher value between the stored number of times of L0p transition L0p TC and the received number of times of L0p transition L0p TC to the number of times of L0p transition L0p TC. According to some example embodiments, the number of times of L0p transition L0p TC may be synchronized.

Referring to FIGS. 3 and 11, some example embodiments of FIG. 11 may further include operations S1100, S1110, and S1120 in the operating method of FIG. 10. Operation S911 may be performed prior to operation S1100, operation S1110, and operation S1120. In some example embodiments, when operation S1100, operation S1110, or operation S1120 is performed prior to operation S911, entry into the recovery state 309 may be made while the conditions in each of operation S1100, operation S1110, or operation S1120 are satisfied, and a period in which the above-described link speed changing operation, according to some example embodiments, is omitted may occur.

In some example embodiments, when the number of times of L0p transition L0p TC is less than or equal to the maximum number of times of transition MAXC, the host may confirm whether there is an attempt to change the link speed (S1100). For example, when there is no attempt to change the link speed, the host may confirm whether there is an attempt to change the link width (S1110). When there is no attempt to change the link width, the host may determine whether to enter the loopback state 310, the hot reset state 311, or the disabled state 312 (S1120). When there is the attempt to change the link speed or the attempt to change the link width, or when entry into the above-described loopback state 310, hot reset state 311, or disabled state 312 is intended, operation S920 is performed. When the entry into the above-described loopback state 310, hot reset state 311, or disabled state 312 is not intended, operation S913 is performed. Meanwhile, in some example embodiments, operations S1100, S1110, and S1120 may be performed prior to operations S931 to S935. In some example embodiments, when operations S931 to S935 are performed prior to operations S1100, S1110, and S1120, there may be no room for determining the transition condition to the recovery state 309 according to the existing PCIe standard. In some example embodiments, such as shown in FIG. 11, operations S1000, S1010, S1020, and S1030 may be omitted as shown in FIG. 9.

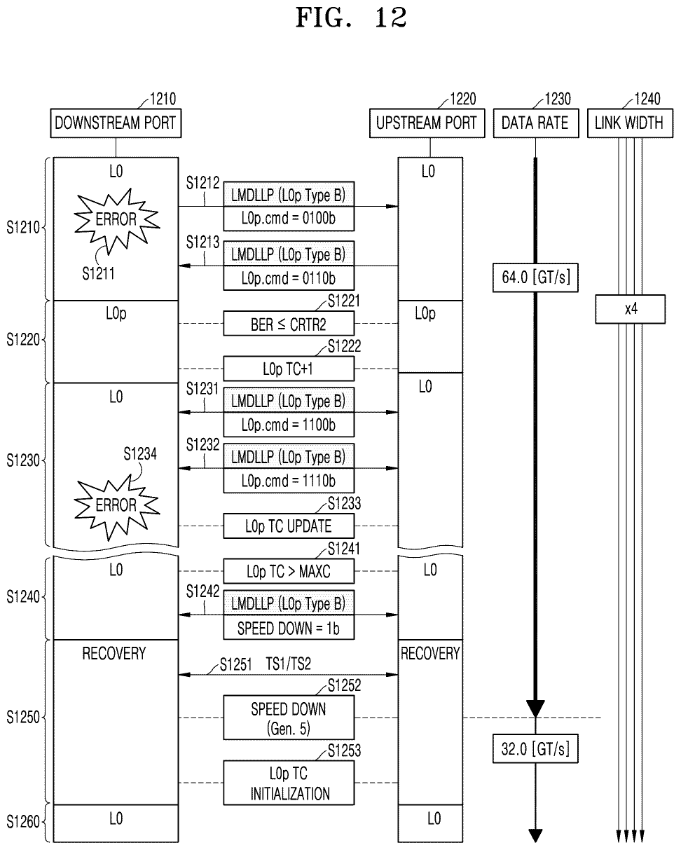

FIG. 12 is a diagram for explaining a method of reducing a link speed according to some example embodiments. Descriptions of some example embodiments of FIG. 12 which are redundant with those given with reference to FIGS. 4 and 5 are omitted. For convenience of description, it is assumed that the number of lanes of the PCIe link 101 is four.

Referring to FIGS. 3 and 12, in some example embodiments a downstream port 1210 and an upstream port 1220 may enter the L0 state 304 (S1210), and transceive packets. An error may occur in the downstream port 1210 and/or the upstream port 1220. For example, in the downstream port 1210, an error may occur due to a packet received from the upstream port 1220 (S1211). In some example embodiments, the downstream port 1210 and the upstream port 1220 may transceive link management DLLPs LMDLLP of “L0p Type B” (e.g., the link management DLLPs 700 shown in FIG. 7) (S1212 and S1213). For example, the downstream port 1210 may transmit or send the link management DLLP LMDLLP of “L0p Type B” to the upstream port 1220. A value of the L0p command field included in the link management DLLP LMDLLP of the downstream port 1210 may be “0100b” (i.e., an L0p request). The upstream port 1220 may also transmit or send the link management DLLP LMDLLP of “L0p Type B” to the downstream port 1210, and the value of the L0p command field included in the link management DLLP LMDLLP of the upstream port 1220 may be, for example, “0110b” (i.e., an L0p request ack). The downstream port 1210 and the upstream port 1220 may enter the L0p state 305 (S1220).

In the L0p state 305, a BER of each of the downstream port 1210 and the upstream port 1220 may be less than or equal to the second criterion value CRTR2 (S1221). In some example embodiments, the downstream port 1210 and the upstream port 1220 may count up the number of times of L0p transition L0pTC one by one (S1222). The downstream port 1210 and the upstream port 1220 may be restored to the L0 state 304 (S1230).

In some example embodiments, the downstream port 1210 and the upstream port 1220 may transceive the link management DLLP LMDLLP of “L0p Type B” in the L0 state 304 (S1231 and S1232). The value of the L0p command field included in the link management DLLP LMDLLP in operation S1231 may be, for example, “1100b” (i.e., an error count report). The value of the L0p command field included in the link management DLLP LMDLLP in operation S1232 may be, for example, “1110b” (i.e., error count report ack). For example, the downstream port 1210 may transmit the link management DLLP LMDLLP of operation S1231 to the upstream port 1220, and the upstream port 1220 may transmit or send the link management DLLP LMDLLP of operation S1232 to the downstream port 1210. For example, the upstream port 1220 may transmit or send the link management DLLP LMDLLP of operation S1231 to the upstream port 1220, and the downstream port 1210 may transmit or send the link management DLLP LMDLLP of operation S1232 to the downstream port 1210. The downstream port 1210 and the upstream port 1220 may update the number of times of L0p transition L0p TC based on the number of times of L0p transition L0p TC provided from the other side and the number of times of L0p transition L0p TC originally stored therein (S1233). Referring to FIGS. 1 and 12, for example, when the downstream port 1210 is the port 111 of FIG. 1, the controller 112 of FIG. 1 may transmit or send a first DLLP to the port 121 through the PCIe link 101. At this time, the first DLLP may include a first number of times of transition, the maximum number of times of transition MAXC, and a first L0p command indicating the error count report. Meanwhile, the controller 122 of FIG. 1 may transmit or send a second DLLP through the PCIe link 101. In some example embodiments, the second DLLP may include a second number of times of transition, the maximum number of times of transition MAXC, and a second L0p command indicating the error count report ack. The controllers 112 and 122 of FIG. 1 may update the number of times of L0p transition L0p TC to a greater number of times of transition between the first number of times of transition and the second number of times of transition. However, example embodiments of the present inventive concepts are not limited thereto, and even when the downstream port 1210 is the port 121 of FIG. 1, an operation may be performed similarly to some of the above-described example embodiments. For example, the controller 122 of FIG. 1 may generate the first DLLP, and the controller 112 of FIG. 1 may generate the second DLLP.

An error may still occur in the downstream port 1210 and/or the upstream port 1220 (S1234). In some example embodiments, after time has elapsed as in operation S1240, the number of times of L0p transition L0p TC may exceed the maximum number of times of transition MAXC in the L0 state 304 in which the downstream port 1210 and the upstream port 1220 have entered (S1241). In some example embodiments, the downstream port 1210 and the upstream port 1220 may transceive the link management DLLP LMDLLP of “L0p Type B” (S1242). A value of a speed down field included in the link management DLLP LMDLLP of operation S1242 may be “1b” indicating that the link speed of the PCIe link 101 is to be reduced. For example, the downstream port 1210 may first transmit or send the link management DLLP LMDLLP of operation S1242 to the upstream port 1220, and then the upstream port 1220 may transmit or send the link management DLLP LMDLLP of operation S1242 to the downstream port 1210. For example, the upstream port 1220 may first transmit or send the link management DLLP LMDLLP of operation S1242 to the downstream port 1210, and then the downstream port 1210 may transmit or send the link management DLLP LMDLLP of operation S1242 to the upstream port 1220. The downstream port 1210 and the upstream port 1220 may enter the recovery state 309 (S1250).

In some example embodiments, a controller may transition from the L0 state 304 to the recovery state 309 after the first DLLP is generated. In some example embodiments, the controller may transmit or send a TS ordered set including a value indicating a lower link speed than the current link speed in the recovery state 309, change the link speed to the lower link speed, and initialize the number of times of transition. In some example embodiments, the controller may transition from the recovery state 309 to the L0 state 304 after the link speed is reduced. In the recovery state 309, the downstream port 1210 and the upstream port 1220 may transceive the TS ordered sets 1 and 2 TS1/TS2 (S1251). For example, the downstream port 1210 or the upstream port 1220 may set the maximum supported data rate to a data rate supported by Gen. 5 (e.g., 32.0 [GT/s]) and transmit or send the TS ordered set 1 TS1 including 32.0 [GT/s] to a port of the other side. The downstream port 1210 or the upstream port 1220 may transmit or send the TS ordered set 1 TS1 including a data rate before the data rate is changed (e.g., 64.0 [GT/s], which is the maximum supportable data rate by Gen. 6) to the port of the other side. The downstream port 1210 and the upstream port 1220 may set a lower data rate among internally stored data rates and received data rates as the maximum supportable data rate. In some example embodiments, the maximum supportable data rate to be newly set may be 32.0 [GT/s]. The downstream port 1210 and the upstream port 1220 may transceive the TS ordered set 2 TS2, so that the change of the maximum supportable data rate may be completed (S1252). The downstream port 1210 and the upstream port 1220 may enter the L0 state 304 (S1260).

According to some example embodiments illustrated in FIG. 12, there is an effect of improving the problems described above with reference to FIG. 4. Specifically, in some example embodiments, there are the effects of reducing or preventing repeated entry of the L0 state 304 and the recovery state 309 without any improvement, maintaining and ensuring continuity of data communication, and improving the communication performance of the system 100, by changing the link speed based on the number of times of entry into the L0p state 305.

According to some example embodiments illustrated in FIG. 12, there is an effect of improving the error of the system 100 and improving the error recovery performance of the system 100, by separating a situation in which restoration to the L0 state 304 has occurred after the entry into the recovery state 309 and a situation in which the L0 state 304 is maintained without the entry into the recovery state 309 according to the protocol and defining the situations in the PCIe standard.

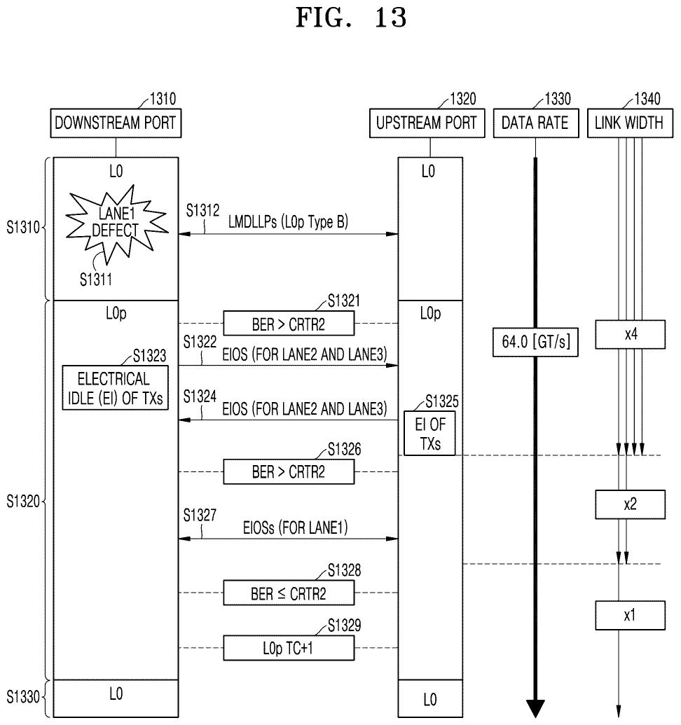

FIG. 13 is a diagram for explaining a method of reducing a link width according to some example embodiments. Descriptions of some example embodiments of FIG. 13 which are redundant with those given with reference to FIGS. 4 and 5 are omitted. For convenience of description, it is assumed that in some example embodiments the number of lanes of the PCIe link 101 is four.

Referring to FIGS. 1, 3, and 13, in some example embodiments, a downstream port 1310 and an upstream port 1320 may enter the L0 state 304 (S1310). At this time, a data rate 1330 may be greater than or equal to 64.0 [GT/s], which is the maximum data rate supported by GEN. 6 of the PCIe standard. A link width 1340 may be “Link width=x4”. In some example embodiments, a defect may occur in a second lane among the four lanes of the PCIe link 101 (see “LANE1” of FIG. 13) (S1311). The downstream port 1310 and the upstream port 1320 may transceive the link management DLLPs LMDLLP of “L0p Type B” (S1312). Operation S1312 may correspond to operations S1212 and S1213 of FIG. 12. The downstream port 1310 and the upstream port 1320 may enter the L0p state 305 (S1320).

As a BER exceeds the second criterion value CRTR2 due to a defect in the second lane in the L0p state 305 (S1321), the downstream port 1310 and the upstream port 1320 may perform operations S931 to S935 described above with reference to FIGS. 9 to 11 in order to lower the BER in the L0p state 305 below the second criterion value CRTR2.

In some example embodiments, the downstream port 1310 and/or the upstream port 1320 may transceive an EIOS to/from a (2^{m-1}+1) lane to a 2^{m}th lane (where m is an integer of 1 or more) among first to 2^{m}th lanes of the PCIe link 101 in the L0p state 305. Referring to FIG. 13, for example, because it is assumed that the number of lanes is 4, m may be 2, the (2^{m-1}+1) lane may be a third lane, and the 2^{m}th lane may be a fourth lane. The downstream port 1310 may transmit the EIOS to the upstream port 1320 through the third lane and the fourth lane (S1322). In some example embodiments, the downstream port 1310 may bring a transmitter of the third lane and a transmitter of the fourth lane among transmitters of the downstream port 1310 into an electrical idle state (S1323). Meanwhile, the upstream port 1320 may transmit or send the EIOS to the downstream port 1310 through the third lane and the fourth lane (S1324). In some example embodiments, the upstream port 1320 may bring the transmitter of the third lane and the transmitter of the fourth lane among the transmitters of the upstream port 1320 into the electrical idle state (S1325). For example, only the first lane and the second lane are activated, and a lane width is changed from “x4” to “x2”.

Even when the number of lanes to be activated is adjusted, a BER may still exceed the second criterion value CRTR2 due to a defect in the second lane in the L0p state 305 (S1326). In some example embodiments, the downstream port 1310 and/or the upstream port 1320 may transceive the EIOS to/from the EIOS to/from a (2^{m-2}+1) lane to a 2^{m-1}th lane among the activated first to 2^{m-1}th lanes of the PCIe link 101 in the L0p state 305. Referring to FIG. 13, for example, when m is 2, the (2^{m-2}+1) lane may be the second lane. Similar to operations S1322, S1323, S1324, and S1325, the downstream port 1310 and the upstream port 1320 may transceive the EIOS to and from the second lane (S1327), and may bring the transmitter of the second lane into the electrical idle state. Only the first lane is activated, and the lane width is changed from “x2” to “x1”.

Because the second lane is excluded from the L0p state 305, the BER in the L0p state 305 may be less than or equal to the second criterion value CRTR2 (S1328). In some example embodiments, the number of times of L0p transition L0pTC may be increased by one (S1329).

According to some example embodiments of FIG. 13, there are the effects of being compatible with a lower version of the PCIe standard, improving the error recovery performance of the system 100, and improving the communication performance of the system 100, by reducing the link width without reducing the link speed while following the LTSSM rule.

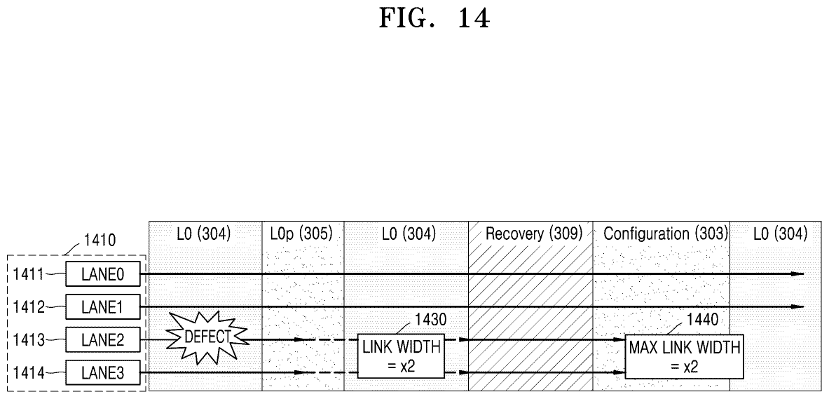

FIG. 14 is a diagram illustrating some example embodiments in which a reduced link width is set to a maximum link width according to some example embodiments of the present inventive concepts.

Referring to FIG. 14, in some example embodiments, a controller may transition from the L0 state 304 to the configuration state 303 after the link width is reduced. In some example embodiments, the controller may set the reduced link width to the maximum link width in the configuration state 303. For example, a defect 1420 may occur in the L0 state 304 in a second lane 1413 of first to fourth lanes 1411, 1412, 1413, and 1414 of a PCIe link 1410. In the L0p state 305, the link width may be changed from “x4” to “x2”. Because the changed link width in the L0p state 305 is a temporary link width, the lanes in an electrical idle state may be reactivated, and when a defective lane is reactivated, the above-described fatal receiver error may occur according to some example embodiments. Therefore, in order to fix the temporarily changed link width, the controller may enter the configuration state 303 and set the changed link width to the maximum link width. When the controller according to some example embodiments is included in a host, the controller may set the temporary link width changed in the configuration state 303 to the maximum link width, and may transmit or send a packet indicating an event with the changed link width to a controller of a PCIe end point. Data of the set link width may be stored in the PCIe registers 112_2 and 122_2 of FIG. 1. The some example embodiments described above may also be applied when the controller according to some example embodiments is included in the PCIe endpoint. In some example embodiments, the controller of the PCIe endpoint may set a separate value and transmit or send the packet PKT including the corresponding value to the host to allow the host to avoid or prevent or reduce reactivation of the corresponding lane in the L0p state 305.

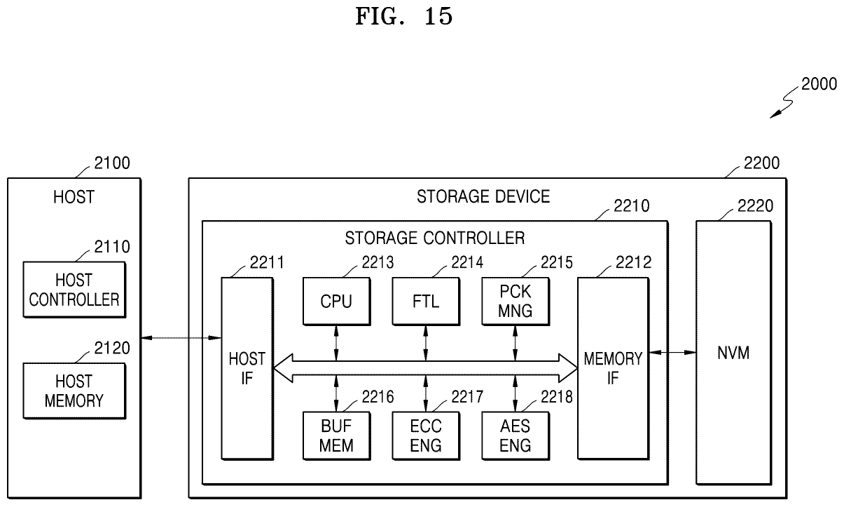

FIG. 15 is a block diagram of a storage system 2000 according to some example embodiments.

Referring to FIG. 15, the storage system 2000 may include a host 2100 and a storage device 2200. The storage device 2200 may include a storage controller 2210 and a non-volatile memory (NVM) 2220. The host 2100 may include a host controller 2110 and a host memory 2120. The host memory 2120 may function as a buffer memory temporarily storing data to be transmitted or sent to the storage device 2200 or data transmitted or sent from the storage device 2200.

In some example embodiments, the example embodiments described above with reference to FIGS. 1 to 14 may be applied to the storage controller 2210 and/or the host controller 2110.

In some example embodiments, the storage device 2200 may include storage media storing data according to a request from the host 2100. As an example, the storage device 2200 may include at least one of a solid state drive (SSD), an embedded memory, or a removable external memory. When the storage device 2200 is an SSD, the storage device 2200 may be a device that complies with the NVM express (NVMe) standard. When the storage device 2200 is an embedded memory or an external memory, the storage device 2200 may be the universal flash storage (UFS) standard or the embedded multi-media card (eMMC). The host 2100 and the storage device 2200 may generate and transmit or send packets according to the respective adopted standard protocols.

In some example embodiments, when the NVM 2220 of the storage device 2200 includes a flash memory, the flash memory may include a two-dimensional (2D) NAND memory array or a three-dimensional (3D) (or vertical) NAND memory array. In some example embodiments, the storage device 2200 may include various other types of NVMs. For example, the storage device 2200 may be applied to Magnetic RAM (MRAM), Spin-Transfer Torque MRAM, conductive bridging RAM (CBRAM), Ferroelectric RAM (FeRAM), Phase RAM (PRAM), Resistive RAM, and other various types of memory.

According to some example embodiments, the host controller 2110 and the host memory 2120 may be implemented as separate semiconductor chips. Alternatively, in some example embodiments, the host controller 2110 and the host memory 2120 may be integrated on the same semiconductor chip. For example, the host controller 2110 may be any one of a plurality of modules provided in an application processor, and the application processor may be implemented as a system on chip (SoC). In some example embodiments, the host memory 2120 may be an embedded memory provided in the application processor, or a NVM or a memory module placed outside the application processor.

The host controller 2110 may manage an operation of storing data (e.g., write data) of a buffer area of the host memory 2120 in the NVM 2220 or storing data (e.g., read data) of the NVM 2220 in the buffer area.

The storage controller 2210 may include a host interface 2211, a memory interface 2212, and a central processing unit (CPU) 2213. In some example embodiments, the storage controller 2210 may further include a flash translation layer (FTL) 2214, a packet manager 2215, a buffer memory 2216, an error correction code (ECC) 2217 engine, and an advanced encryption standard (AES) engine 2218. The storage controller 2210 may further include a working memory (not shown) in which the FTL 2214 is loaded, and a write operation and a read operation on the NVM 2220 may be controlled by the CPU 2213 executing the FTL 2214.

The host interface 2211 may transceive packets to and from the host 2100. A packet transmitted or sent from the host 2100 to the host interface 2211 may include a command or data to be stored in the NVM 2220, and a packet transmitted from the host interface 2211 to the host 2100 may include a response to the command or data read from the NVM 2220. The host interface 2211 may be implemented to comply with a standard protocol such as PCIe. The memory interface 2212 may transmit or send data to be stored in the NVM 2220 to the NVM 2220 or receive read data from the NVM 2220. The memory interface 2212 may be implemented to comply with a standard protocol such as toggle or an open NAND flash interface (ONFI).

The CPU 2213, which may be a processor, may receive data and a command signal from the outside, output a plurality of control signals to memory interface 2212 based on the command signal, and output a clock signal and data to the memory interface 2212.

The flash transaction layer 2214 may perform several functions such as address mapping, wear-leveling, and garbage collection. Address mapping is an operation of converting a logical address received from the host 2100 into a physical address used to actually store data in the NVM 2220. Wear-leveling is a technology for reducing or preventing excessive deterioration of a specific, or alternatively desired block by uniformly using blocks within the NVM 2220, and may be implemented through firmware technology for balancing erase counts of physical blocks. Garbage collection is a technology for securing usable capacity within the NVM 2220 by copying valid data of a block to a new block and then erasing the existing block.

The packet manager 2215 may generate a packet according to a protocol of an interface consulted with the host 2100 or may parse various types of information from the packet received from the host 2100. In some example embodiments, the buffer memory 2216 may temporarily store data to be stored in the NVM 2220 or data to be read from the NVM 2220. In some example embodiments, the buffer memory 2216 may be a component provided in the storage controller 2210, but in some example embodiments may be placed outside the storage controller 2210.

The ECC engine 2217 may perform an error detection and correction function on read data read from the NVM 2220. More specifically, the ECC engine 2217 may generate parity bits with respect to write data to be stored in the NVM 2220, and the generated parity bits may be stored in the NVM 2220 along with the write data. When reading data from the NVM 2220, the ECC engine 2217 may correct an error in the read data by using parity bits read from the NVM 2220 together with the read data and output the error-corrected read data.

The AES engine 2218 may perform at least one of an encryption operation and a decryption operation on data input to the storage controller 2210 by using a symmetric-key algorithm.

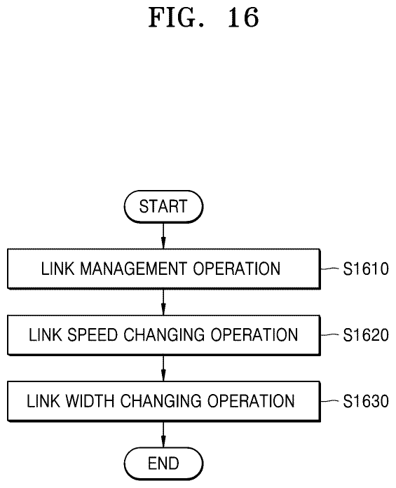

FIG. 16 is a flowchart of an operating method of a semiconductor device according to some example embodiments.

Referring to FIG. 16, in some example embodiments, the operating method of the semiconductor device may include a link management operation S1610, a link speed changing operation S1620, and a link width changing operation S1630.

In the link management operation S1610, a controller of the semiconductor device may transceive a link management DLLP through a PCIe link including a plurality of lanes in an L0 state of a PCIe. The link management DLLP may include the number of times of transition and the maximum number of times of transition. The number of times of transition may be the number of times a state transitions from the L0 state to an L0p state. The link management operation S1610 may correspond to operations S1210, S1212, and S1213 of FIG. 12 according to some example embodiments. The link management operation S1610 may correspond to operations S1310 and S1312 of FIG. 13 according to some example embodiments.

In some example embodiments, the link management DLLP may include a DLLP type field, a link management type field, a speed down field, an L0p command field, an L0p entry limit field, and an L0p entry count field. The link management DLLP according to some example embodiments may correspond to some example embodiments shown in FIG. 7.

In the link speed changing operation S1620, the controller of the semiconductor device may set a link speed lower than a link speed of a PCIe link in a recovery state of the PCIe based on a first number of times of transition greater than the maximum number of times of transition. The link speed changing operation S1620 may correspond to operations S1220 to S1242 of FIG. 12 according to some example embodiments.

In the link width changing operation S1630, the controller of the semiconductor device may set a link width less than a link width of the PCIe link in the L0p state of the PCIe based on a second number of times of transition less than or equal to the maximum number of times of transition. The link width changing operation S1630 may correspond to operations S1320 to S1328 of FIG. 13 according to some example embodiments.

In some example embodiments, the link management operation S1610 may include transceiving a first link management DLLP including a first L0p command and a second link management DLLP including a second L0p command. The first L0p command may indicate an L0p request for transition of the L0p state. The second L0p command may indicate an L0p request ack in response to the L0p request. In some example embodiments, the link management operation S1610 may include increasing the number of times of transition by one based on whether a BER of the data packet received through the PCIe link in the L0p state exceeds a criterion value in the L0p state transitioned from the L0 state.

In some example embodiments of the link management operation S1610, the link management operation S1610 may further include transceiving a third link management DLLP including a first number of times of transition corresponding to the changed number of times of transition and a third L0p command. The third L0p command may indicate an error count report requesting the number of times of transition. The link management operation S1610 may further include transceiving a fourth link management DLLP including a second number of times of transition and a fourth L0p command. The fourth L0p command may indicate an error count report ack as a response to the error count report. The link management operation S1610 may further include updating the number of times of transition to a greater number between the first number of times of transition and the second number of times of transition.

In some example embodiments, the link management operation S1610 may include transceiving link management DLLPs including a first value notifying that the link speed is to be changed. The above-described operation, according to some example embodiments, may correspond to operations S1240 and S1242 of FIG. 12. The link speed changing operation S1620 may include transmitting a first TS ordered set including a first value indicating a first maximum supportable data rate, receiving a second TS ordered set including a second value indicating a second maximum supportable data rate, and setting the link speed based on a value indicating a smaller maximum supportable data rate between the first value and the second value. The above-described operations may, according to some example embodiments, correspond to operations S1250, S1251, and S1252 of FIG. 12.

In some example embodiments, the link width changing operation S1630 may include calculating a BER of the data packet received through the PCIe link in the L0p state, and transmitting EIOS to at least one target lane selected according to a predetermined, or alternatively desired lane idle order and the number of lane idles among the plurality of lanes based on a first BER exceeding a criterion value. The above-described operations, according to some example embodiments, may correspond to operations S1320 to S1327 of FIG. 13. Thereafter, the link width changing operation S1630 may further include transitioning from the L0p state to the L0 state based on a second BER less than or equal to the criterion value. The above-described operation, according to some example embodiments, may correspond to operations S1328 and S1330 of FIG. 13.

As described herein, any devices, electronic devices, modules, units, and/or portions thereof according to any of the example embodiments, and/or any portions thereof may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

Any of the memories described herein may be a nonvolatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM).

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

While some example embodiments of the present inventive concepts has been particularly shown and described with reference to some example embodiments thereof, it will be understood that various changes in form and details may be made therein without departing from the spirit and scope of the following claims.

What is claimed is:

1. A semiconductor device, comprising:
a peripheral component interconnect express (PCIe) link comprising a plurality of lanes; and
a controller configured to
perform a communication operation of transceiving of a data link layer packet (DLLP), the DLLP including a number of times of transition and a maximum number of times of transition from an L0 state to an L0p state of a PCIe through the PCIe link, based on a first bit error rate (BER) of a data packet received through the PCIe link and a first criterion value in the L0 state, and
determine whether to perform, based on the number of times of transition and the maximum number of times of transition, at least one of a link speed changing operation of reducing a link speed of the PCIe link in a recovery state of the PCIe, or a link width changing operation of reducing a link width of the PCIe link in the L0p state.

2. The semiconductor device of claim 1, wherein the controller is configured to
generate a value notifying that the link speed is to be changed, based on the number of times of transition being greater than the maximum number of times of transition, and
transceive a first DLLP including the value through the PCIe link.

3. The semiconductor device of claim 2, wherein the controller is configured to
transition from the L0 state to the recovery state after the first DLLP is generated,
in the recovery state, send a training sequence (TS) ordered set including a value indicating a lower link speed than a current link speed, change the link speed to the lower link speed, and initialize the number of times of transition, and
transition from the recovery state to the L0 state after the link speed is reduced.

4. The semiconductor device of claim 1, wherein the controller is configured to
transition from the L0 state to the L0p state, based on the number of times of transition less than or equal to the maximum number of times of transition, and
in the L0p state, based on a second BER greater than a second criterion value greater than the first criterion value, send an electrical idle ordered set (EIOS) through the PCIe link with respect to at least one target lane selected according to a lane idle order and a number of lane idles among the plurality of lanes.

5. The semiconductor device of claim 4, wherein the controller is configured to
increase the number of times of transition by one in the L0p state, based on a third BER less than or equal to the second criterion value, and
transition from the L0p state to the L0 state after the number of times of transition is increased.

6. The semiconductor device of claim 5, wherein the controller is configured to
transition from the L0 state to a configuration state of the PCIe through the recovery state after the link width is reduced, and
set the reduced link width to a maximum link width in the configuration state.

7. The semiconductor device of claim 1, wherein the controller is configured to
transition from the L0 state to the L0p state, based on the number of times of transition being less than or equal to the maximum number of times of transition,
maintain the link width and increase the number of times of transition by one in the L0p state, based on a third BER being less than or equal to a second criterion value and greater than the first criterion value, and
transition from the L0p state to the L0 state after the number of times of transition is increased.

8. The semiconductor device of claim 7, wherein the controller is configured to
send a first DLLP including a first number of times of transition, the maximum number of times of transition, and a first L0p command indicating an error count report requesting the number of times of transition through the PCIe link,
receive a second DLLP including a second number of times of transition, the maximum number of times of transition, and a second L0p command indicating an error count report acknowledgment (ack) in response to the error count report through the PCIe link, and
update the number of times of transition to a greater number of times of transition between the first number of times of transition and the second number of times of transition.

9. The semiconductor device of claim 1, wherein the DLLP includes a DLLP type field indicating a link management DLLP, a link management type field indicating an error count type among a plurality of types of link management, a speed down field including a value indicating speed down, an L0p command field indicating an L0p command or an L0p response, an L0p entry limit field indicating the maximum number of times of transition, and an L0p entry count field indicating the number of times of transition.

10. An operating method of a semiconductor device, the operating method comprising:
a link management operation of transceiving a link management data link layer packet (DLLP), the DLLP including a number of times of transition and a maximum number of times of transition from an L0 state to an L0p state of a peripheral component interconnect express (PCIe), through a PCIe link including a plurality of lanes in the L0 state;
a link speed changing operation of setting a link speed lower than a link speed of the PCIe link in a recovery state of the PCIe, based on a first number of times of transition being greater than the maximum number of times of transition; and
a link width changing operation of setting a link width less than a link width of the PCIe link in the L0p state of the PCIe, based on a second number of times of transition being less than or equal to the maximum number of times of transition.

11. The operating method of claim 10, wherein the link management DLLP includes a DLLP type field indicating a DLLP type, a link management type field indicating an error count type among a plurality of types of link management, a speed down field including a value indicating whether to perform speed down, an L0p command field indicating an L0p command or an L0p response, an L0p entry limit field indicating the maximum number of times of transition, and an L0p entry count field indicating the number of times of transition.

12. The operating method of claim 10, wherein the link management operation includes
transceiving a first link management DLLP including a first L0p command indicating an L0p request for transition of the L0p state, and a second link management DLLP including a second L0p command indicating an L0p request ack in response to the L0p request; and
increasing the number of times of transition by one, based on whether a bit error rate (BER) of a data packet received through the PCIe link in the L0p state transitioned from the L0 state exceeds a criterion value, in the L0p state.

13. The operating method of claim 12, wherein the link management operation includes
transceiving a third link management DLLP including a first number of times of transition corresponding to the changed number of times of transition and a third L0p command indicating an error count report requesting the number of times of transition;
transceiving a fourth link management DLLP including a second number of times of transition and a fourth L0p command indicating an error count report acknowledgment (ack) in response to the error count report; and
updating the number of times of transition to a greater number of times of transition between the first number of times of transition and the second number of times of transition.

14. The operating method of claim 10, wherein the link management operation includes
transceiving link management DLLPs including a first value notifying that the link speed is to be changed, and
the link speed changing operation includes
sending a first training sequence (TS) ordered set including a first value indicating a first maximum supportable data rate;
receiving a second TS ordered set including a second value indicating a second maximum supportable data rate; and
setting the link speed based on a value indicating a smaller maximum supportable data rate between the first value and the second value.

15. The operating method of claim 10, wherein the link width changing operation includes
calculating a bit error rate (BER) of a data packet received through the PCIe link in the L0p state; and
sending an electrical idle ordered set (EIOS) to at least one target lane selected according to a lane idle order and a number of lane idles among the plurality of lanes, based on a first BER exceeding a criterion value.

16. A semiconductor device, comprising:
a port connected to a peripheral component interconnect express (PCIe) link, wherein
the port is configured to transceive a data link layer packet (DLLP) in an L0 state of a PCIe, and
the DLLP includes a DLLP type field indicating a link management DLLP, a link management type field indicating an error count among a plurality of types of link management of the PCIe, a speed down field indicating whether to speed down on a speed of the PCIe link, an L0p command field indicating an L0p command or an L0p response, an L0p entry count field indicating a number of times of transition from the L0 state to the L0p state of the PCIe, and an L0p entry limit field indicating a maximum number of times of transition with respect to the number of times of transition.

17. The semiconductor device of claim 16, wherein the port is configured to
transceive a first link management DLLP including a first L0p command indicating an L0p request for transition of the L0p state, and a second link management DLLP including a second L0p command indicating an L0p request acknowledgement (ack) in response to the L0p request in a first L0 state, and
transceive a third link management DLLP including a third L0p command indicating an error count report requesting the number of times of transition, and a fourth link management DLLP including a fourth L0p command indicating an error count report ack in response to the error count report in a second L0 state after the first L0 state.

18. The semiconductor device of claim 16, wherein the port is configured to
transceive link management DLLPs including a value indicating that a link speed of the PCIe link is to be reduced in a third L0 state after the second L0 state, and
transceive a training sequence (TS) ordered set including a value indicating a lower link speed than a current link speed in a recovery state transitioned from the third L0 state.

19. The semiconductor device of claim 18, wherein the port is configured to
transceive a first link management DLLP including a first L0p command indicating an L0p request for transition of the L0p state, and a second link management DLLP including a second L0p command indicating an L0p request acknowledgement (ack) in response to the L0p request in the L0 state, and
transceive an electrical idle ordered set (EIOS) to or from a (2^{m-1}+1) lane to a 2^{m}th lane (where m is an integer of 1 or more) among first to 2^{m}th lanes of the PCIe link in an L0p state transitioned from the L0 state.

20. The semiconductor device of claim 19, wherein the port is configured to transceive the EIOS to or from a (2^{m-2}+1) lane to a 2^{m-1}th lane among the activated first to 2^{m-1}th lanes in the L0p state.
